(19) United States
(12) Patent Application Publication
(10) Pub. No.: US 2016/0065571 A1
(43) Pub. Date: Mar. 3, 2016

(54) SYSTEM AND METHODS FOR SECURE FILE SHARING AND ACCESS MANAGEMENT

(71) Applicant: Hoyos Labs Corp.

(72) Inventors: Hector Hoyos, New York, NY (US); Scott Streit, Baltimore, MD (US); Jason Braverman, Toronto (CA)

(21) Appl. No.: 14/836,557

(22) Filed: Aug. 26, 2015

Related U.S. Application Data
(63) Continuation-in-part of application No. 14/638,787, filed on Mar. 4, 2015.
(60) Provisional application No. 62/041,964, filed on Aug. 26, 2014.

(51) Int. Cl. H04L 29/06; H04L 29/08

(52) U.S. Cl. CPC H04L 63/0861; H04L 67/06; H04L 67/306; H04L 63/0435

(57) ABSTRACT

Disclosed is a system and method for coordinating secured access to an access-controlled environment. A plurality of keys are stored, each associated with a user account and generated by executing a biometric authentication application, using identification information concerning the respective user and a component of the of the respective computing device. Access-control information identifies an access-controlled environment, and a transmission is received from a computing device that includes a respective key and an indicator indicating that the user's identity has been biometrically confirmed by the computing device. The key confirms that the user has been biometrically authenticated, and that the transmission is not a replay of a previously received transmission from the computing device. Access to the access-controlled environment is facilitated as a function of the verification, determination and confirmation.

### CROSS-REFERENCE TO RELATED APPLICATIONS

This patent application is based on and claims priority to U.S. Patent Application Ser. No. 62/041,964, entitled “SYSTEM AND METHODS FOR SECURE FILE SHARING AND ACCESS MANAGEMENT” filed Aug. 26, 2014, and is a continuation-in-part to U.S. patent application Ser. No. 14/638,787, entitled “SYSTEM AND METHOD FOR BIOMETRIC PROTOCOL STANDARDS” filed Mar. 4, 2015, and further this patent application is related to U.S. Patent Application Ser. No. 61/822,746, entitled “SYSTEM AND METHOD FOR PROVIDING BIOMETRICALLY AUTHENTICATED ACCESS USING MOBILE DEVICES” filed May 13, 2013; U.S. Patent Application Ser. No. 61/842,800, entitled “SYSTEM AND METHOD FOR PROVIDING BIOMETRICALLY AUTHENTICATED ACCESS USING MOBILE DEVICES” filed Jul. 3, 2013; U.S. Patent Application Ser. No. 61/842,739, entitled “SECURE BACK-END ARCHITECTURE SYSTEM AND METHOD” filed Jul. 3, 2013; U.S. Patent Application Ser. No. 61/842,757, entitled “SYSTEM AND METHOD FOR GENERATING A BIOMETRIC IDENTIFIER” filed Jul. 3, 2013; U.S. Patent Application Ser. No. 61/842,756, entitled “SYSTEMS AND METHODS FOR DETERMINING LIVENESS” filed Jul. 3, 2013; U.S. Provisional Patent Application Ser. No. 61/921,004, entitled “SYSTEM AND METHOD FOR DETERMINING LIVENESS” filed Dec. 26, 2013; U.S. Provisional Patent Application Ser. No. 61/920,985, entitled “SYSTEM AND METHOD FOR GENERATING A BIOMETRIC IDENTIFIER” filed Dec. 26, 2013; U.S. Provisional Patent Application Ser. No. 61/922,438, entitled “SYSTEM AND METHOD FOR BIOMETRIC PROTOCOL STANDARDS” filed Dec. 31, 2013; U.S. Patent Application Ser. No. 61/924,092, entitled “SECURE BACK-END ARCHITECTURE SYSTEM AND METHOD” filed Jan. 6, 2014; U.S. Patent Application Ser. No. 61/924,097, entitled “SYSTEM AND METHOD FOR SMARTPHONE SECURITY CASE” filed Jan. 6, 2014; U.S. patent application Ser. No. 14/201,438, entitled “SYSTEMS AND METHODS FOR BIOMETRIC AUTHENTICATION OF TRANSACTIONS” filed on Mar. 7, 2014; U.S. patent application Ser. No. 14/201,462, entitled “SYSTEMS AND METHODS FOR DETERMINING LIVENESS” filed Mar. 7, 2014; and U.S. patent application Ser. No. 14/201,499, entitled “SYSTEM AND METHOD FOR GENERATING A BIOMETRIC IDENTIFIER” filed on Mar. 7, 2014; U.S. patent application Ser. No. 14/276,753, entitled “SYSTEM AND METHOD FOR AUTHORIZING ACCESS TO ACCESS CONTROLLED ENVIRONMENTS” filed May 13, 2014; U.S. Patent Application Ser. No. 62/010,880, entitled “SYSTEM AND METHOD FOR FACILITATING USER ACCESS TO AUTOMOBILES BASED ON BIOMETRIC INFORMATION” filed Jun. 11, 2014; U.S. Patent Application Ser. No. 62/041,803, entitled “SYSTEMS AND METHODS FOR DETERMINING LIVENESS” filed Aug. 26, 2014, each of which is hereby respectively incorporated by reference as if set forth in its respective entirety herein.

### FIELD OF THE INVENTION

The present application relates to systems and methods for sharing digital data, in particular, systems and methods for managing peer to peer data sharing between biometrically authenticated users.

### BACKGROUND OF THE INVENTION

While the Internet is a great source of information for the masses, privacy and secure ownership of data is difficult to maintain. Once information or data is created by an individual and transmitted out to others, it can become accessible to many individuals unknown to the original creator. Even in situations in which a user creates a “private” profile on a social media website and limits access to select individuals, some of the profile information is still accessible by unauthorized individuals, and the website may also maintain the ability to use the user's information (e.g., photos) in advertisements or marketing campaigns without the user's knowledge and without any compensation for that use. Thus, there is a need for a system for private sharing of digital content that allows the creator to maintain control and ownership over the content he or she transmits to others.

### SUMMARY

In accordance with one or more implementations of the present application, disclosed herein is a technological infrastructure for providing secure access to digital media content and preserving ownership of digital media content. In one or more implementations, the present application provides a peer-to-peer digital media content delivery and sharing system that protects a user's data by controlling who has access to the data. The data ownership features provide the ability to maintain ownership and protect, as much as possible, the user's private data (even private data that they agree to share). For example, a user may agree to share a picture with a friend, but still control further sharing by not agreeing to let the friend post that picture anywhere else. In one or more implementations, the present application provides a single sign-on (SSO) system that allows a user to access one or more websites using his or her biometric information. SSO provides a way for the user to login to any website using their biometric identity, without having to share or trust a username or password.

In at least one other implementation, system and method are provided for coordinating secured access to an access-controlled environment. A plurality of keys are stored, each associated with a user account and generated by executing a biometric authentication application, using identification information concerning the respective user and a component of the of the respective computing device. Access-control information identifies an access-controlled environment, and a transmission is received from a computing device that includes a respective key and an indicator indicating that the user's identity has been biometrically confirmed by the computing device. The key confirms that the user has been biometrically authenticated, and that the transmission is not a replay of a previously received transmission from the computing device. Access to the access-controlled environment is facilitated as a function of the verification, determination and confirmation.

Other features and advantages of the present application will become apparent from the following description of the invention that refers to the accompanying drawings.

### BRIEF DESCRIPTION OF DRAWINGS/FIGURES

FIG. 1 is a high-level diagram of a digital media content delivery and sharing system in accordance with at least one implementation of the present patent application;

FIG. 2 is an example implementation and process flow diagram of secure digital media content delivery and sharing in accordance with one or more implementations of the present patent application;

FIG. 3 is an example process flow diagram for a single sign-on system that allows a user to access a website using his or her biometric information in accordance with one or more implementations of the present patent application;

FIG. 4 is an example high-level web diagram of the operations of a secure digital media content delivery and sharing application in accordance with one or more implementations of the present patent application;

FIG. 5 is an example implementation and process flow diagram for the importing and encryption of digital media files via a secure digital media content delivery and sharing application in accordance with one or more implementations of the present patent application;

FIG. 6 is an example flow diagram displaying the transmission of the encrypted electronic file and the file information within the secure digital media content delivery and sharing system in accordance with one or more implementations of the present patent application;

FIG. 7 illustrates an example sequence for an “opening file” API operation for a secure digital media content delivery and sharing application in accordance with one or more implementations of the present patent application;

FIG. 8 illustrates an example sequence for a “deleting file” API operation for a secure digital media content delivery and sharing application in accordance with one or more implementations of the present patent application;

FIG. 9 illustrates an example sequence for a “sharing file” API operation for a secure digital media content delivery and sharing application in accordance with one or more implementations of the present patent application;

FIG. 10 illustrates an example sequence for a “saving file” API operation for a secure digital media content delivery and sharing application in accordance with one or more implementations of the present patent application;

FIG. 11 is an example process flow diagram for the opening and viewing an encrypted digital media file using a secure digital media content delivery and sharing application in accordance with one or more implementations of the present patent application;

FIG. 12 is an example process flow diagram for managing access to files using a secure digital media content delivery and sharing application in accordance with one or more implementations of the present patent application;

FIG. 13 is an high-level block diagram showing the relationship between account groups and system groups within a secure digital media content delivery and sharing system in accordance with one or more implementations of the present patent application;

FIG. 14 is example process flow diagram for the management of local groups using a secure digital media content delivery and sharing application in accordance with one or more implementations of the present patent application;

FIG. 15 is an example process flow diagram for the revocation of shared access to a secured file using a secure digital media content delivery and sharing application in accordance with one or more implementations of the present patent application;

FIG. 16 is an example process flow diagram for transmitting an encrypted email in accordance with one or more implementations of the present patent application; and

FIG. 17 is an example process flow diagram for receiving an encrypted email in accordance with one or more implementations of the present patent application.

### DETAILED DESCRIPTION

In accordance with one or more implementations of the present application, disclosed herein is a technological infrastructure for providing secure access to digital media content and systems.

The present application provides an infrastructure that includes a biometric authentication and identity assertion platform in conjunction with data-transmission protocols, for transmitting information between pre-configured, e.g., “enrolled,” devices with a platform implementing Biometric Open Protocol Standards (referred to herein, generally, as “BOPS”) and the “1U App” and described in greater detail, herein.

As used herein, the term “HoyosID” refers generally to a biometrics-based identity assertion and access management platform that eliminates a need for traditional usernames and passwords for gaining secured access (e.g., “logging on”) to a system and/or completing a transaction with electronic devices. HoyosID is more fully described in co-pending and commonly assigned U.S. patent application Ser. No. 14/276,753, entitled “SYSTEM AND METHOD FOR AUTHORIZING ACCESS TO ACCESS CONTROLLED ENVIRONMENTS” filed May 13, 2013, which is incorporated by reference as if expressly set forth in its entirety herein. In one or more implementations, HoyosID can utilize a camera device that is configured with and/or that operates in conjunction with an electronic device, and that captures a user's biometric information.

As used herein, the term “1U App” refers generally to a software application that is installable on computing devices (e.g., mobile devices/smartphones, tablet computers, desktop computers and the like). Devices having the 1U App installed are configured to interface with a back-end server infrastructure that utilizes one or more biometric platforms associated with HoyosID. This, in conjunction with technology provided with a mobile computing device, e.g., a smartphone, provides a secure and improved alternative to systems that are secured using password protection. Using the biometric authentication technology of HoyosID, a device configured with and operating the 1U App can provide users with secured access to systems, including but not limited to online systems such as websites or accounts, or doors to buildings, dwellings, or vehicles. Accordingly, the 1U App in conjunction with HoyosID technology eliminates a need for users to carry one or more items to identify themselves (e.g., identification cards, credit cards, passports, driver licenses, access tokens, or the like). Moreover and as further described herein, in one or more implementations a device configured with 1U App provides a user with secure access and control over his or her digital media content.

In one or more implementations of the present application, HoyosID combines biometrics-based user recognition technology with one or more secure authentication and access control protocols to provide a user with secured access to his or her digital media content (e.g., photos, videos, documents), as well as with secured access to a system or service. In one or more implementations, HoyosID can also include additional “liveness” detection to verify that the correct actual, living person is providing authentication and gain access to content, a system, service or secured environment. One particular biometric and/or combinations of biometrics can be used for authentication, for example, including face, iris, periocular, voice, vein pattern, or other suitable biometric. Accordingly, BOPS and devices configured using the 1U App are not limited to one particular biometric authentication modality.

As noted herein, the HoyosID can support Biometric Open Protocol Standards (BOPS). In certain implementations, BOPS can encompasses rules governing secure communication between various electronic devices and/or a server, as more fully described in co-pending and commonly assigned U.S. patent application Ser. No. 14/587,633, entitled “SYSTEM AND METHOD FOR BIOMETRIC PROTOCOL STANDARDS” filed Dec. 31, 2014, which is incorporated by reference as if expressly set forth in its entirety herein. A plurality of devices, e.g., a trusted server computing device and configured client computing device(s) implementing BOPS, referred to generally as a “BOPS architecture,” can support a two-way secure socket layer (“2-way SSL”)/transport layer security (“TLS”) connection over an encryption mechanism to a server. Moreover, a BOPS architecture can also employ an intrusion detection system, including for secured access, for example, to online systems such as websites or accounts, or doors to buildings, dwellings, or vehicles. Use of 2-way SSL provides that each communicating device (e.g., mobile computing device) verifies the identity of the BOPS server as a function of a certificate installed on the mobile client device, and also the BOPS server verifies the identity of the mobile computing device as a function of a certificate installed on the mobile computing device, which is unique for each user paired with one respective user device. Additionally, in one or more implementations, TLS uses a 571 bit Elliptic Curve Cipher. Accordingly, the communications can be secured using a 2 way SSL environment in which each communicating side is 1024 or 2048 bits in length, and a TLS layer which is 571 bits of ECC encryption, which makes up the transport layer.

As noted herein, in addition to secured access the present application provides a technological infrastructure that enables users to control the sharing of and access to their respective digital media content. Such digital media content can include, for example, multimedia content such as text, still images, video, audio and/or any combination thereof). Digital media content can also, include, for example, software programs and/or applications (e.g., mobile apps) operable on one or more mobile computing devices. In one or more implementations of the present application, controls are provided for access control and sharing with other users of digital media content, such as content that is stored on a respective computing device. Such controls enable users to maintain ownership and control of digital media content, including by ensuring that the number and/or identity of any users who attempt and/or successfully access and/or share the digital media content can be determined and stored. In one or more implementations, controls are provided to recall or otherwise disable access to digital media content that was previously sharable (or shared) with others. In addition, access to previously shared digital media content can be revoked. Thus, one or more features are provided herein that enable users of configured computing devices to maintain full control over digital assets, even after sharing and transmitting such assets was provided previously to another user's device.

Further, features are provided herein to increase accountability, such as by generating and transmitting information when a user accesses digital media content and thereafter takes some unauthorized action, such as attempting to copy and transmit the content to another device without permission. For example, a user takes an unauthorized screenshot of an image that was transmitted from a device configured with the 1U App. The user then transmits the screenshot without permission or authorization to another device. In accordance with the present application, information about the user's device can be sent to another device, such as a device operated by the original owner of the content. By informing the content owner about the unauthorized activity, the owner can take action to hold the offending user accountable.

In one or more implementations the 1U App can include functionality for a user to select an area of an image (i.e., the digital media content in this example), and modify pixels in the selected area to insert a symbol, e.g., an “invisible watermark,” such that the original image appears the same to viewers. Thus the original digital media content is modified to include the new symbol. Any subsequent digital files (e.g., formatted in a JPEG, BMP, TIFF or other suitable file format) that are based on the modified digital media content, such as copies, will include the watermark. The watermark can be identifiable by a device operating the 1U App. In one or more implementations, the receiving device of the digital media content, as unmodified, modifies the content (e.g., the image file) with the invisible watermark or other suitable content, and information associated with the recipient is embedded. For example, information associated with the recipient, the recipient's computing device, the respective copy of the 1U App installed on the recipient's computing device, the network (e.g., IP address) or the like is embedded. Thereafter, if the user sends the modified content (e.g., the image file) outside of the infrastructure of the present application, such as transmitting a screenshot (i.e., a copy) of the image to a device that is not configured with the 1U App, the screenshot will still contain embedded information. This can identify, for example, which user the unauthorized copy came from, thereby allowing the rightful owner to take action against the sending user.

Although the previous example regarded image content, such as an image file, the present application supports various multimedia content formats. For example, an audio or video file can be modified to embed information that is not readily perceptible, such as audio information in the file.

By way of further example, an image file having a multicolor background is provided from a device operated by a first user (e.g., the “owner” of the content) to a device operated by a second user. The 1U App executing on the second user's device can be configured to identify a portion of the image, such as a 256×256 pixel area, and select certain colors within the area, and then modify shades of the colors in that area to appear close but not identical to the original. The device operating the 1U App can, thereby, create a uniquely identifiable pattern. Accordingly, the device operating the 1U App effectively keeps the image visually intact, but makes an alteration that includes a unique pattern or other identifiable feature, such as embedded digital data (like a QR code) into the digital media content that the 1U App enabled user devices and/or a BOPS server can identify. In case the second user forwards the image, such as to a social network, (e.g., Facebook), the original owner operating the 1U App or the BOPS server can identify the device and/or the user who forwarded the image, because the image was tagged to the user and/or device that received the image, including as a function of metadata, the pattern and/or one or more unique identifiers.

By way of a still further example, the 1U App can operate on a computing device that generates and/or transmits digital media content, and can further operate on one or more devices that receive the content, as well as on a BOPS server. A computing device operating the 1U App can embed a code in a location or portion of a digital file and record information regarding the location or portion in memory. In one or more implementations, the location or portion may be randomly selected by the 1U App. Information regarding the location or portion (and optionally at least a portion of the code itself) can be stored in memory in association with the particular digital media content, for example, in an inventory entry that was made when the file (e.g., image file) was generated and/or shared with a recipient. In the event that unauthorized sharing occurs, a device executing the 1U App can determine where to look for the code using the location or portion. Using the code identified at the location or portion, the individual/device that shared the digital media can be identified. In one or more implementations, the code and information regarding the random location can be embedded by one more of the receiving device, transmitting device and/or the system server. Moreover, the code identification and decoding features can be performed by authorized 1U App enabled user devices (e.g., the creator of the content) or the back-end system server device (e.g., BOPS server), alone or in combination.

In one or more implementations, the present application provides a peer-to-peer digital media content delivery and sharing system that protects a user's data by controlling access to the data as well as by reporting on sharing of content (e.g., where content has been shared, when content has been shared, etc.). In particular, the peer-to-peer system provides a user with the ability to control access to his or her digital media content by eliminating a need for the user to send the digital media content to a remote server for storage and subsequent transmission or delivery to one or more third parties, which may result in unintended users accessing the digital media content without the user's consent.

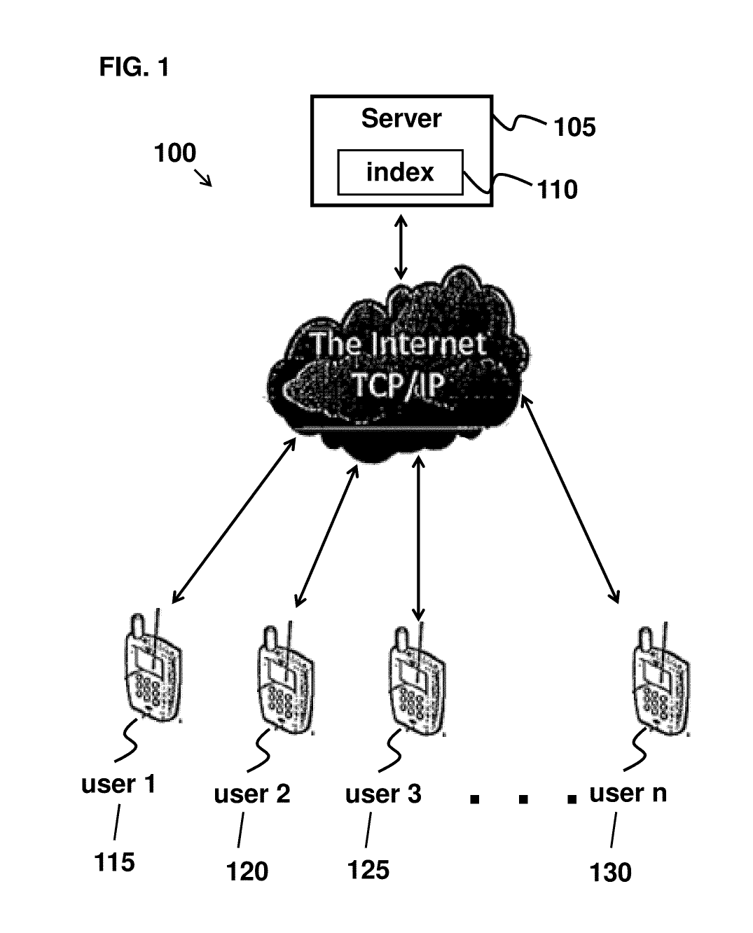

A high-level diagram of an example peer-to-peer digital media content delivery and sharing system in accordance with at least one implementation of the present application is shown in FIG. 1. Further understanding of the present application can be attained by reference FIG. 1 and the following example, which describes a peer-to-peer digital media content delivery and sharing system (100) in accordance with at least one implementation of the present application. In the example system 100 shown in FIG. 1, a server (105) encompasses a server index (110), described in greater detail. In an example with reference to the System (100) shown in FIG. 1, user 1 (115) operating a smartphone executing the 1U App takes a photograph using the smartphone and wants to transmit the image file (or a copy of the image file, referred collectively as the “image file,” herein) containing the photograph to other users. The other users are also enrolled with the system (100) and use mobile devices executing the 1U App. Restricting access to content (e.g., the image file) to other enrolled users preserves digital rights protection in the shared content. Prior to transmitting the image file to another user (or prior to opening the 1U App), the first user (user 1 [115]) can be biometrically authenticated so as to verify the first user's (user 1's [115]) identity and to authenticate the image file to be transmitted. Prior to transmitting the image file, the user 1 (115) also identifies at least one other user (user 2 [120]) who is an intended recipient of the photograph and user 1 (115) has approved access to the image file.

The mobile device configured by the 1U App can also store the image file in a memory. In addition, the device configured by the 1U App can encode the image file with additional information (e.g., metadata), such as one or more identifiers associated with the user, the image file and information concerning access/sharing rules. Moreover, the image file can be encrypted such that the file is only accessible by users who have been biometrically authenticated and are using devices executing or otherwise configured by the 1U App.

More specifically, when user 1 (115) generates the photo and/or sends the photo to user 2 (120) as further described herein, an entry concerning the photo can be created in a server index (110) maintained by the server (105). In either implementation, the server (105) creates an inventory entry in the server index (110). The inventory entry can be used to record information about, for example, the sender of the image file, the recipient of the image file, and the image file (or various other digital media content) itself. Inventory entries can also include information about subsequent transactions involving the image file, for example, instances of user access, sharing and/or transmission between users. In this manner, inventory entries can be updated or appended to previous inventory entries thereby creating an index (110) that provides a comprehensive audit trail for each digital media file generated or shared using the system.

In particular, the inventory entry can include a DeviceID, userID, and biometric index for both the originator (sender) of the image file (in this example, user 1 [115]) and the recipient of the image file (in this example, user 2). The inventory entry can also include a unique content ID for the image file that is sent. As used herein, the DeviceID refers to a unique identification marker for the devices used in the particular transaction, which in this example are the smartphone used by user 1 (115) to send the image file, and the device used by user 2 (120) to receive and/or access the image file. As used herein, the userID refers to each user's identification markers for the 1U App, as all senders and recipients, in accordance with at least this implementation, must be 1U App users to participate in the sharing of the image file (or other digital media content). As used herein, biometric index refers generally to a key or other such identifier that includes or is generated based on a user's biometric information and is unique to that user. As noted above, biometric authentication of a plurality of users (e.g., sender and recipient(s)) can be necessary for the transaction (e.g., sharing of the image file) to occur. As used herein, the unique content ID refers generally to a unique identification code given for the particular electronic file (in this example, the image file) that is being shared. The content ID can be generated by the mobile device configured by the 1U App or, in addition or alternatively, the remote server (105). In this example, an inventory entry for the transaction between user 1 (115) and user 2 (120) can be created in the server index (110) when user 2 (120) receives biometrically authenticated approval from user 1 (115) via the 1U App to receive and/or access the image file.

Continuing with the present example, after user 1 (115) transmits the image file to user 2 (120), user 2 (120) must be biometrically authenticated via a device configured using the 1U App in order to receive and/or view the image file. For example, the image file can be immediately sent to user 2's (120) device and stored in the 1U App secure memory location and access to the image file can be provided to user 2 (120) upon biometric authentication using the 1U App. In one or more implementations, the image file can be sent to the remote server (105) for temporary or permanent storage and for further transmission to user 2's (120) device upon biometric authentication of user 2. In other implementation(s), a notification can be transmitted to user 2's (120) device and only upon biometric authentication of user 2 (120) will the image file actually be transmitted from user 1's (115) device to user 2's (120) device. Accordingly, it can be appreciated that the digital media file can be transmitted via the server (105) or alternatively directly between users through one or more communications channels that do not include the server (105).

In this manner, the systems and methods disclosed herein can be used to facilitate file sharing across a peer-to-peer network in which one or more central servers (e.g., 105) link the users who have files with those users who request files or are authorized recipients. Although some of the example implementations are described herein are implemented in a peer-to-peer (P2P) network environment, the particular network configuration is not limited to traditional P2P network configurations. P2P systems may not include a server side application that controls messaging; instead each user device can be a ‘node’ on the network that communicates independently of other nodes or a central managing device. In some implementations, however, communications can be governed by a system server that controls, identifies and secures transactions. Actual movement of data, however, can be implemented in a peer-to-peer environment, in that it is not sent via the system server but directly from the origination party to the destination party.

Continuing with the example, in some instances one of the other users (user 2 [120]) that received the image file from user 1 (115) might want to forward the image file to a third party (user 3 [125]). In one or more implementations, if user 3 (125) is an approved recipient, user 2 (120) must receive biometrically authenticated approval from user 1 to further transmit the image file. If user 3 (125) is not an approved user, an approval request can be sent to user 1 (115) requesting authorization for user 2 (120) to forward the image file to user 3 (125). If biometrically authenticated authorization of the transaction is not received from user 1 (115), then the forwarding of the image file to user 3 (125) is not permitted.

More specifically and in one or more implementations, user 2's (120) computing device executing the 1U App can detect an attempt to transmit the image file, by user 2 (120). For example, upon attempting to send the image file, metadata in or otherwise associated with the file can cause the device executing (or otherwise configured by) the 1U App to transmit a notification to the server (105). The notification can cause the server (105) to verify access rules or sharing permissions associated with the image file, such as via the inventory entry/entries stored in the index (110). If user 2 (120) is not authenticated to transmit the image file to user 3 (125), a notification and/or a biometrically authenticated approval request can be sent by the system server (105) to user 1's (115) device requesting user 1's (115) authorization for user 2 (120) to forward the image file to user 3 (125). When user 1 (115) receives the approval request from user 2 (120), user 1 (115) must first bio-authenticate his identity via a computing device executing or otherwise configured by the 1U App. Once user 1 bio-authenticates his identity, and provides approval for the forwarding of the image file to user 3 (125), the approval and bio-authentication from user 1 (115) are routed back through the server (105) and sent to user 2 (120). Once user 2 (120) has approval from user 1 (115), the image file can be transmitted by the 1U App on user 2's (120) device to user 3 (125), either automatically based on user 2's (120) previous attempt or manually by user 2 (120).

When user 3 (125) bio-authenticates his identity using a computing device executing or otherwise configured by the 1U App and receives the image file from user 2 (120), the server index (110) can create a new inventory entry for this transaction. In addition or alternatively the new inventory entry/entries can be created upon user 2 (120) transmitting the image file and/or upon user 1 (115) approving the transmission to user 3 (125). The inventory entry/entries can include the DeviceID, userID, and biometric index for users 2 (120) and 3 (125), and the unique content ID for the image file. The new inventory entry can be linked to the previous inventory entry/entries for the initial transaction between user 1 (115) and user 2 (120) (i.e., when user 1 [115] first shared the image file with user 2 [120]).

Continuing with the present example, the image file can be stored on individual computing devices (e.g., mobile devices such as smartphones), including the device on which the image file originates (user 1's [115] device) and the devices of those users whom user 1 has share the image file with (user 2 [120] and user 3 [125]). The image file can be stored on the individual devices within a memory location associated with the 1U App installed on the device. In some implementations, the computing device executing or otherwise configured by the 1U App can store the image file in a specific location of the memory dedicated to data files generated or transmitted or received using the 1U App. In this manner files stored by the computing device configured by the 1U App are accessible only via use of the 1U App and control over such files can be maintained or otherwise managed by the server (105) and/or the mobile device in conjunction with the 1U App.

As noted above, the digital media file (e.g., the image file) can include or be associated with metadata that can include the unique content ID, the biometric index, the DeviceID, and the userID for the originating user (e.g., user 1 [115]). The metadata can also be used to link the digital media file to the server index (110) and trigger the approval/verification and other access control processes upon any attempt to send and/or share a the digital media file with a user.

In one or more implementations, the server index (110) includes an audit trail of users who have received, viewed and/or stored the image file and includes access rules/permissions that control the manner in which files are shared and because the digital media files are stored in the device memory in a manner such that the files are only accessible using the system, the initial user who sends and/or shares a photo from his or her device (in this example, user 1 [115]) can also revoke access and/or cause the image file to be removed from the devices of users who were subsequently given access to the image file. For instance and continuing with this example, user 1 (115) using a computing device executing the 1U App can later generate revocation instructions to revoke access to the image file by user 2 (120) and user 3 (125). The revocation instructions are transmitted to and received by the server (105), and the server (105) can transmit instructions to devices to cause each respective user's device executing or configured by the 1U App that has the image file in memory to be deleted and, optionally, metadata associated with the image file.

Additionally, when access to digital media content (e.g., the image file) is revoked, the inventory entry/entries associated with digital media content and the authorized user(s) can also be erased from the server index (110) or otherwise modified to reflect the revocation of access. In a similar manner, a user can cause the deletion of any of his/her digital media content on any number of other user devices including his/her own device and records of the file from the server (105). Similarly, users can also recall, modify or replace portions of shared digital media content, for example, recalling and replacing an attachment to a previously transmitted email. In one or more implementations, both the sending (recalling) and receiving users can use computing devices executing or otherwise configured by the 1U App as email clients. Notwithstanding the particular email client (e.g., Microsoft Outlook) used by the receiving user, as long as the receiving user is using a computing device executing or otherwise configured by the 1U App, the device connects to the server (105) or server and the content is deleted.

Further, users can use devices operating the 1U App to integrate with social networking websites (e.g., Facebook, LinkedIn) to gather their contacts, and invite those contacts to use the 1U App. In one or more implementations, users of devices operating the 1U App can identify their most important contacts, and the device operating the 1U App can display content from the important contacts first (e.g., emails), and content from other contacts second. In one or more implementations, a device operating the 1U App can implement Google Translate API to provide email translation in dozens of different languages, depending on which language the sending user wants the recipient user to see.

Accordingly, the systems and methods disclosed herein facilitate auditing media file sharing and provide a user complete control over his/her own digital media files even though they may reside on another 1U App user's device and even after they are accessed by the recipient.

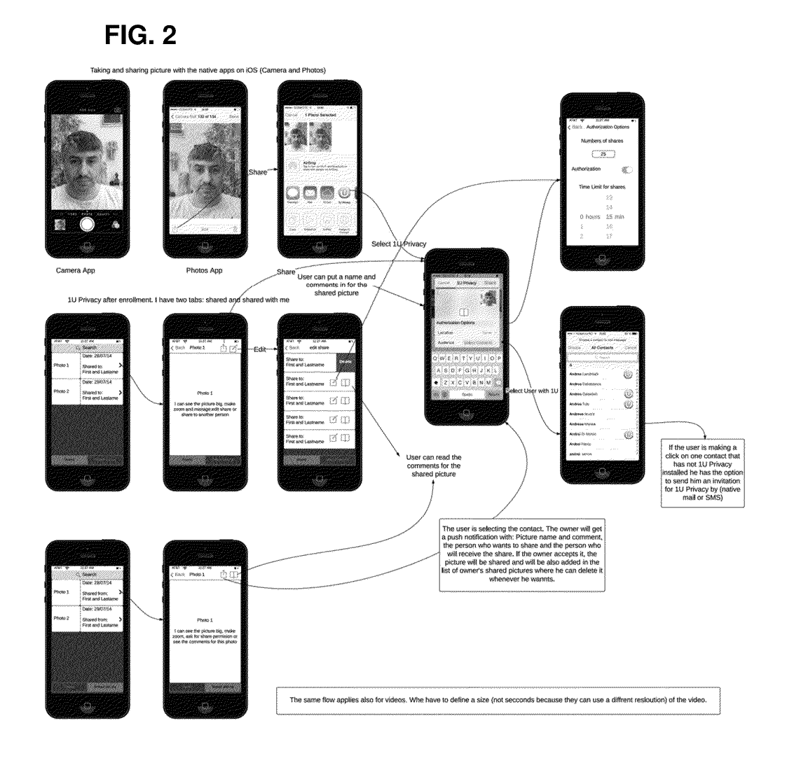

Although the above example references the sharing (and recall of) of a photo, one or more implementations of the present application can also utilize other types of electronic files (digital media content), including but not limited to video files, word document files, emails, electronic files attached to emails, text chat messages, SMS messages, Voice Calls, Video calls, Emoji sharing, documents and other electronic data files. Further, while user 1 (115) in the example above uses a smartphone to send the electronic file (e.g., photo), other electronic devices can be used to send and/or receive electronic files in accordance with one or more implementations of the present application, including but not limited to desktop computers, laptop computers, tablet computers, and other portable electronic devices. Further, the sharing and control (e.g., modifying/deleting) of files in accordance with one or more implementations can be between unlimited numbers of users (user n [130]). Additionally, in accordance with one or more implementations, each user must bio-authenticate his or her identity using the 1U App on his or her electronic device in order to send and/or receive an electronic file via the 1U App, or to send or respond to an approval request via the 1U App. An example implementation and process flow of secure sharing of files between users using a device operating the 1U App, in accordance with one or more implementations, is shown in FIG. 2.

Preferably, the electronic files (digital media content [e.g., photos]) shared between users in accordance with one or more implementations of the present application are not stored in any back-end server. Instead, all photos and/or other digital media content are stored in each individual user's device(s) secured by the 1U App and HoyosID (BOPS/biometrics protection). Further, in one or more variations, attempts to use/modify the photos or other digital media content from the device can cause the device operating the 1U App to generate an alarm with an ID request (e.g., biometrically authenticate the user and confirmation of the user's access rights, or prompt the originating user to provide biometrically authenticated approval of the activity) to the original sender of the content to either authorize or deny further action with that content file. For example, ID request can be prompted by: attempts to copy a file, move the file to another storage medium or another location in the storage medium, access the file using another application, transmit, modify the file, delete the file and other such user interactions with a file.

Preferably, all digital media content are kept in the BOPS-protected mobile devices and encrypted by one or more encryption keys as further described herein. Further, the technological infrastructure of the present application is designed to encrypt all outgoing digital media content being sent to another user. In one or more implementations, all digital media content used in accordance with the present invention can be encrypted. The encryption of the digital media content can be accomplished using a key generated from one or more of, a biometric index, user identifiers identifying the user and mobile device identifiers uniquely associated with the mobile devices used by the user. Accordingly, the digital media content can be encrypted such that it would become unreadable to any party attempting to access it without authorization. Such encryption can occur as the electronic files are created, shared or otherwise selected for encryption.

For example, the digital media content can be encrypted using one or more of: a user's biometric information, a user identifier, liveness information, or mobile device information uniquely associated with the user device running the 1U App as an encryption key. For example, using a key derivation function one or more secret keys can be generated from unique user information such as biometric information. The keys are therefore uniquely associated with the user by virtue of being derived from the information specific to the enrolled user and/or user device. Moreover, a combination of the foregoing can be used to create a complex unique key for the user that can be encrypted using Elliptic Curve Cryptography, in some implementations at least 571 bits in length, and stored on the mobile device. In addition, that key can be used to secure the user data stored on the mobile device and/or the system server.

More specifically, enrolled user devices executing the 1U App can be configured to transmit encrypted messages to other enrolled users via the server. As noted above, preferably, all communications between an enrolled user device and the system server can be sent via 2-way SSL secure communication environment using a key that was generated for a user based on, for example, the user's biometric identifier, other user and/or device identifiers and/or keys generated during enrollment or a combination of the foregoing. Using an asymmetric key made of the users own biometric data provides a key that is unique to the user and as such is useable to assert the user's identity.

In case the sending user is biometrically authenticated, a 2-way SSL/TLS connection can be established between the system server and the mobile device for every such transaction (e.g., session or transmission) as discussed above. Once this secure connection is created, all data sent by the user across the SSL/TLS layer can be encrypted using the previously mentioned key generated during enrollment. This provides a robust, secure method of transport for all data types between the sending device and the system server.

A salient aspect of the file-sharing platform is that it biometric authentication and identity assertion are supported to transmit/store/receive or access the encrypted information, thereby providing a high level of protection and security for the information as it passes from a user to another user via the system server. The only device with an ability to decrypt the messages can be the system server, which contains the overall algorithm used to encrypt and decrypt messages and manages the 2-Way SSL secure communications environment with user devices. In the event that this algorithm was made public, each user's data is still safe, because no user data needs to reside on the system server and all information can reside with the users on their devices, and only with a valid biometric authentication, under a valid 2-way SSL connection can the information be communicated between the user devices and the system server.

Upon receiving the encrypted message from the sending user, the system server can securely forward the message to the intended recipient or transmit a notification to the intended recipient informing them that a secure message is waiting to be delivered. In particular, the system server can require the intended recipient to be biometrically authenticated and authorized, and, if successful, the system server can decrypt the message. In addition, the system server can establish a 2-way SSL communication session with the intended recipient's device in order to forward the message to the recipient in a secure manner.

The biometric data used in accordance with the present application is not sent to a remote server, but rather it can be maintained in a user's individual electronic device. As such, the matching of the biometric authorization with the specific digital media content file can be done locally on the electronic device in real time. More specifically, an asymmetric key comprising the user's own biometric data provides a unique encryption method for securing the digital media content. In at least one implementation, the biometric vectors are encrypted using a 571-bit elliptic curve cipher, which renders the information unreadable for unauthorized users attempting to access the information.

In one or more implementations, a user can form a group of users whom he or she wants to share digital files with. In forming this group, the user can send encrypted digital media content to the entire group, and only those users in the group can decrypt the digital media content files. In some implementations, the user 1 can identify any number of other users who can access and perform various actions using the shared file. The individuals and the approved actions can be defined on an individual basis or group level access and sharing permissions can be defined. For example, a first group of most trusted users can be approved by the user 1 to receive, share and modify a file (e.g., copy, edit, save, modify, broadcast, share and the like) without restraint through any number of avenues (e.g., facebook, twitter, e-mail, etc.). Other users can be approved to access particular files and can be provided permission to take only certain actions with the file (e.g., view and share with other approved users through devices operating the 1U App for a limited duration). It can be appreciated that the access permissions can therefore identify users that are approved to receive the file(s) and define limitations as to what the recipients can do with the file, how they can take those actions and how long the access lasts.

As stated previously, in one or more implementations, the architecture of BOPS can enable a two-way SSL/TLS connection. In one or more implementations, the technological infrastructure of the present application utilizes an SSL/TLS connection for each transaction between users, and it can also include all of the unique information about a user's electronic device and incorporate that information with that user's biometric data. Once this connection is created, all digital media content (data) sent across the SSL/TLS connection can be further encrypted using the previously mentioned 571-bit elliptic curve cipher, thereby providing additional security for the transmission of the digital media content. As noted above, transmissions can be routed through the system server, in addition or alternatively a secure connection can be established between user devices. For example, to establish a peer to peer connection the system server can check/verify the certificates of both mobile devices and then the two mobile devices can establish a secure connection between the two devices without routing through the system server.

In one or more implementations, the technological infrastructure of the present application can also include 1U Global ID. As used herein, the term “1U Global ID” refers generally to a single sign-on system/platform that allows a user to access one or more websites using his or her biometric information via the BOPS-compliant Hoyos ID platform as credentials for signing on to the website(s). The 1U Global ID system can also include the 1U App for use by the consumer (user) via his or her electronic device.

Using a two-way SSL/TLS connection the BOPS-compliant Hoyos ID platform (“BOPS/HoyosID”) can be integrated into a website via the 1U Global ID platform, thereby providing secure identity assertion without the website having to deploy BOPS in their back-end servers or HoyosID identity assertion platform. However, it can be appreciated that the BOPS/HoyosID platform can similarly be deployed in whole or in part on the back-end enterprise servers. For websites that utilize 1U Global ID (in conjunction with and BOPS/HoyosID), consumers (users) can log in (sign on) to the websites using their biometric information via the device operating the 1U App rather than a username and/or password. Biometric log-in using 1U Global ID and BOPS/HoyosID provides additional security over conventional username/password log-in systems, in which a user's credentials (username and/or password) can easily be compromised.

It can be appreciated that the features and functionality of the 1U Global ID system including the BOPS/HoyosID platform can be implemented as a stand-alone system (e.g., system server) that is communicatively coupled to an enterprise computing system (e.g., a webserver, or other enterprise system facilitating secure access). It can also be appreciated that various features and functionality of the 1U Global ID platform, BOPS/HoyosID platform can similarly be deployed and implemented on an enterprise system or across any number of devices. Accordingly, processes described as being performed by distinct devices, such as a webserver and the BOPS/HoyosID system server, should be understood as encompassing processes being performed by platforms or modules and the like which are implemented within a single system.

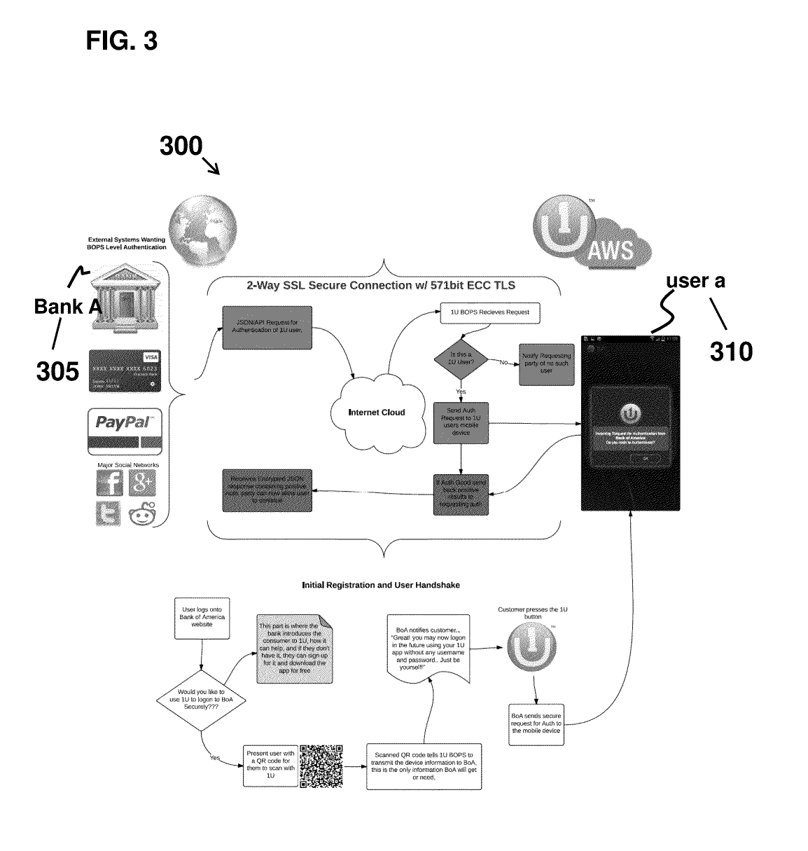

An example process flow for a single sign-on system (1U Global ID) that allows a user to access a website using his or her biometric information, in accordance with one or more implementations, is shown in FIG. 3. Further understanding of the integration of 1U Global ID and BOPS/HoyosID platform and processes into an enterprise system hosting a website, in accordance with at least one implementation of the present application, can be attained by reference to the following examples and FIG. 3.

With reference to FIG. 3, an example implementation is provided that concerns a user (310) log in to Bank A's website (305) using 1U Global ID system (300) which has been integrated into Bank A's enterprise system that hosts the website (305). The 1U Global ID system operates on the bank server in connection with BOPS/HoyosID identity assertion platform. The process can begin with receipt of a user's request to access the secure website by the Bank A server. It can be appreciated that the request to log into the website can be received by the server directly from a user's personal computer or the user's mobile device. For example, the user can select the desired banking service on their mobile device, for example via a native banking app or a browser-based bank website, or via the device operating the 1U App or web-based 1U-app interface, and the like. The user selection can also specify a particular device on which the user desires to gain secure access to the website, for example, the user can select web banking on the user's personal computer (which has been enrolled with the 1U Global ID system) or mobile app banking on the user's mobile device. After the user makes the selection, the request to access can be transmitted routed through a network and received by the Bank A server (305).

Bank A server (305) the server can then prompt the 1U Global ID platform, in conjunction with the BOPS/HoyosID platform, to determine whether user a (310) is in fact a user of the 1U Global ID system (300) (e.g., whether user a [310] has enrolled for use of the 1U App on his or her electronic device and/or a personal computer (not shown)).

If user a and/or user a device were not enrolled with the 1U Global ID system, the BOPS/HoyosID platform would provide a notification back to the Bank A's server (305) stating that user a (310) was not a 1U user. In that case, user a (310) would be denied access to Bank A's website by the Bank A server. In this case, because user a (310) is a 1U user, once the BOPS/HoyosID platform verifies that user a (310) is a 1U user, a request for authentication is securely transmitted to user a's (310) mobile device.

Responsive to the authentication request the user can be prompted to capture his or her biometric information by his or her mobile device (310), and the mobile device can authenticate his or her identity in order to gain access to Bank A's website (305). In one or more implementations, user a (310) can provide his or her biometric information using a camera device that is configured with or that operates in conjunction with an electronic device that uses the camera device to capture the user's biometric information and biometrically authenticates the user.

User a's (310) device then sends a request for authorization to access the website that includes biometric authentication confirmation to Bank A's server (305). Based on the biometric authentication confirmation received from user a's (310) device, Bank A's server (305) further verifies user a's (310) identity using the 1U Global ID platform (in conjunction with the BOPS/HoyosID platform). Provided the user's authorization request is verified using the 1U Global ID then the Bank A's server (305) can provide user a access to Bank A's website (305).

Access to the Bank A website can be provided by the Bank A server (305) through the user's mobile device and/or via any of the user's personal computing devices that have also been enrolled with the 1U Global ID sign on system. In some implementations, if the user requested access on his personal computing device, in response to receipt of the biometric authentication confirmation from the user's mobile device, the banks server, using the 1U Global ID platform (in conjunction with the BOPS/HoyosID platform) can identify whether the user's personal computing device is enrolled with the 1U Global ID platform and, if so, using the 1U Global ID platform (in conjunction with the BOPS/HoyosID platform) send a command to the computing device that causes the computing device to automatically launch a web-browser and provide direct and pre-authorized access bank A website (or in other implementations launch a native banking application). Accordingly, because the user identity has been verified using the mobile device, the Bank A server using the 1U Global ID platform (in conjunction with the BOPS/HoyosID platform) can provide instant access via the user's personal computing device without requiring further user authentication on that device and without requiring any user interaction with the computing device or browser.

Preferably, communications between the user devices and the back end systems during the identity assertion process (e.g., the request to access the website, the authentication request and the authentication confirmation) are conducted using a two-way SSL/TLS communication environment established in conjunction with the BOPS-compliant Hoyos ID platform. (“BOPS/HoyosID”). The secure communication environment can be established directly between the bank A (305) server and the user device (310), for example if the BOPS-compliant Hoyos ID platform were integrated into the bank system. Alternatively the secure communications environment can be established between the bank server and end user indirectly by the BOPS-compliant Hoyos ID identity assertion platform that is in secure communication with the user devices and in secure communication with the Bank A (310) server through its integration with the 1U Global ID platform. For example, the user's biometric authentication confirmation can be transmitted to the standalone BOPS/HoyosID server which in turn can facilitate the user's access by forwarding or providing confirmation of the user's biometric authentication to the Bank A webserver and the Bank A webserver can grant access to the user's device accordingly. Accordingly, it can be appreciated that the processes for identity assertion and providing access can be coordinated by the bank server or by the BOPS/HoyosID platform or a combination of the foregoing.

In another example (referring to FIG. 3 [bottom]), a user logs on to a Bank's website using his or her mobile device. The Bank has both a conventional log-in system (using a username and password) as well as the 1U Global ID using the 1U Global ID platform (in conjunction with the BOPS/HoyosID platform). The user logs into the Bank's website using the conventional log-in system using his or her mobile device. Once the user has logged into the website, the webserver can provide the user with a prompt on his or her mobile device that asks the user if he or she would like to use 1U Global ID to log into the Bank's website securely. If the user replies positively (“yes”) to the prompt (assuming the user is not already a 1U Global ID user), the Bank A server can provide the user's mobile device with a prompt with a link allowing the user to download the 1U App on to his or her mobile device. If the user is already a 1U user (or once the user downloads the 1U App onto his or her mobile device), the Bank A server transmits a QR code to scan using the device operating the 1U App. The user scans the QR code using the device operating the 1U App, and the app transmits the code and user's device information to the Bank's server. The QR code, paired with the user device information and the user's identity is then used by the server to create a secure login identity for the user. The bank's website then sends a notification back to the user's mobile device that notifies the user that he or she may now log in to the Bank's website using his or her biometric information via the device operating the 1U App.

As with other implementations of the present invention, users can use the 1U Global ID system to log in to websites integrated with 1U Global ID and BOPS/HoyosID using a variety of electronic devices, including but not limited to desktop computers, laptop computers, tablet computers, and other portable electronic devices.

According to a salient aspect, the present application provides an infrastructure for single sign on (SSO) that does not use a username or token, owned by another party to authenticate a person for access to a secondary system. As a primary example is the Facebook Connect product, which allows people to easily login to various websites using their facebook identity. The problem with this is that if the facebook login is compromised, then the attacker can gain access to any website accepting Facebook Connect as the user. This is the reason why no financial institution uses this type of SSO product. It provides convenience, with LESS security. 1U Global ID on the other hand provides maximum security without any username or password ever needed. The 1U Global ID and platform provides a “Trusted Identity Router” meaning, the system “Connects” the party requesting identification (e.g., the secure website or access controlled environment), with the actual user, who then authenticates with their own biometric identity. As such, the back end HoyosID/BOPS system servers are not required to store anything of value, but is nonetheless capable of matching the two parties (e.g., the user and the party requesting identification) together with a high level of security.

Additional features of a device operating the 1U App and the technological infrastructure of the present application are further described herein. The example implementations are further referred to herein, as “1U Turing,” which refers generally to an application implemented on client side devices (e.g., mobile devices/smartphones, tablet computers, desktop computers and the like) and back-end server infrastructure that utilize the biometric authorization platform of HoyosID along with smartphone technology. 1U Turing allows a user to more easily share digital media files with a group and/or distribution list of other users registered in the system via user authentication with BOPS. Other operations can also be performed on digital media files via 1U Turing including but not limited to importing, encrypting, decrypting, saving, deleting, and managing shared access. As further described herein, 1U Turing can be configured to provide both business-to-consumer and business-to-business implementations. In general, the 1U Turing application executing on respective devices includes encoded instructions in the form of one or more software modules that, when executed by the processor of the computing device, configure the processor to perform the various processes described herein.

In one or more implementations, 1U Turing can also include a 1U Turing mobile interface used for integration into the 1U App. More specifically, this mobile interface configures a user's mobile device to receive inputs from 1U users and serves to facilitate the operations of 1U Turing in conjunction with the device operating the 1U App. In one or more implementations, 1U Turing can also be implemented as a Desktop client. The following examples/figures generally relate to the operation of 1U Turing using the mobile interface. However, it can be appreciated that the features and functionality of 1U Turing could also be implemented on any number of computing devices, e.g., as a desktop client.

In one or more implementations, 1U Turing can integrate with third party applications. More specifically, 1U Turing can be configured to access local and remote storage and files associated with respective third party applications (e.g., facebook, instagram, email applications and the like) and can otherwise integrate with the features and functions of those third party applications, for instance, via an API. 1U Turing can also include a user interface from which the user can access features and perform operations using the 1U Turing app and using third party applications. In particular, the user interface can include components such as a file importer, a file browser, a file viewer, a local groups manager, a file share access manager, and a setting section.

In one or more implementations, the file browser is the main screen of 1U Turing. The file browser can be a table or grid in which each cell represents a locally stored file or folder. The files stored locally can be either secured (encrypted) or not secured, and in at least one implementation the file status of each file is denoted by an icon (e.g., closed lock for a secured file, open lock for a non-secured file). From the file browser screen, a user can initiate the management of stored files or groups of files, and access other administrative screens in the 1U Turing component. For example, from the file browser screen the user can manage files by sorting them by certain criteria (e.g., name, type), choosing the format in which they are displayed (e.g., table, grid), moving the files (e.g., via drag and drop), deleting the files, or renaming the files. Other actions that can be initiated from the file browser screen include, but are not limited to viewing files (or decrypting and then viewing), encrypting unsecured files, and editing share access rights to files. These management actions can also be taken on folders containing one or more files. The different actions that can be performed on the files using 1U Turing are explained in more detail below.

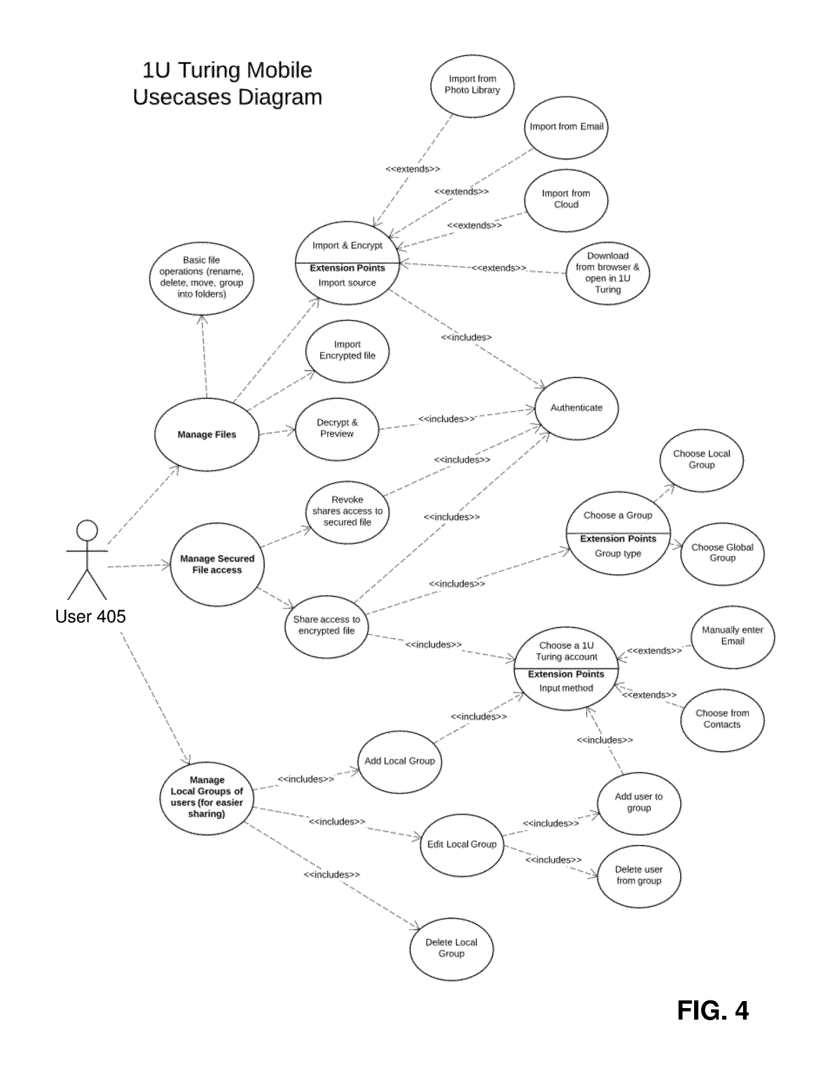

An example web diagram of the operations of 1U Turing is shown in FIG. 4. As shown in FIG. 4, the user 405 can manage files (e.g., import, encrypt, decrypt), manage secured access to the files (e.g., share access, revoke access), and manage groups of users for local sharing (e.g., add a group, edit a group, delete a group). Certain operations (e.g., encryption, decryption, granting access, revoking access) require the user to authenticate his or her identity prior to completing the operation, while other operations (e.g., revoking access to a file from another user) do not necessarily require user authentication.

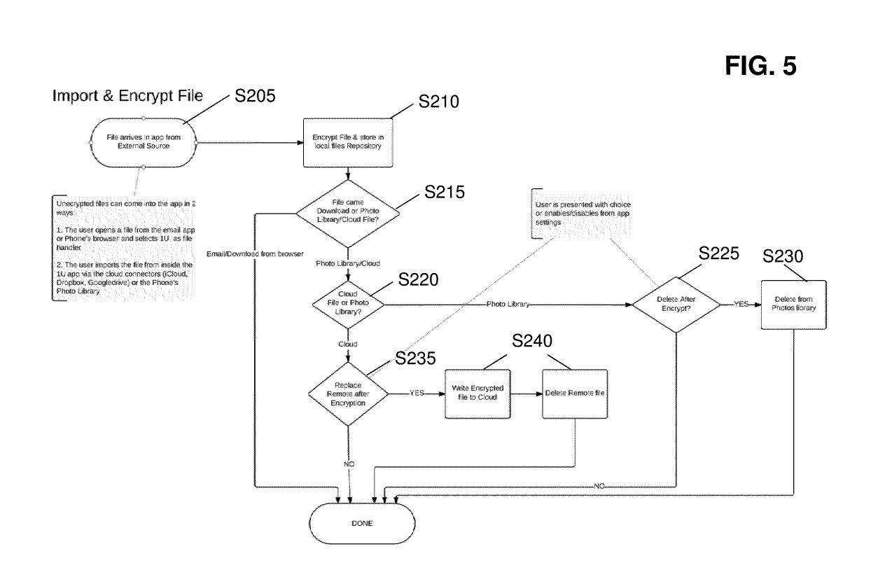

A new user of 1U Turing can begin using the application by importing one or more digital media files and encrypting those files. An example process flow diagram for the importing and encryption of digital media files is shown in FIG. 5. The process begins at step S205, where a digital media file is imported into 1U Turing. More specifically, the 1U Turing application configures the processor of the mobile device to retrieve one or more digital media files. As with other aspects of the technological infrastructure of the present application, the digital media files can be any digital media file type, including but not limited to word documents, pdf files, image files (e.g., jpeg), text files, video files, and CSV files. The processor can be configured to retrieve these files from various sources including but not limited to the memory of the user's computing device (e.g., mobile device), cloud storage (e.g., Dropbox, GoogleDrive, iCloud), email attachments, browser downloads, and applications on the computing device that support file sharing with other applications. The importation of one or more digital media files can be initiated from within the 1U Turing user interface. For example, 1U Turing can configure the processor to receive a user input (e.g., via an “Import” button in the file browser component) causing the processor to import of one or more files. Alternatively, in at least one implementation, the importation of one or more digital media files can be initiated from outside of 1U Turing. For example, a user can select 1U Turing as the destination for the file when opening an email attachment or when downloading a file from the internet using a third party application integrated with the 1U Turing application and, as a result, the 1U Turing app configures the processor to import the downloaded file into 1U Turing.

With continued reference to FIG. 5, once the file has been imported to 1U Turing, at step S210 the file is encrypted. Specifically, in one or more implementations, 1U Turing configures the processor to receive a user input (e.g., request to encrypt the specific file) that causes 1U Turing (executed by the processor) to encrypt the digital media file. Alternatively, the 1U Turing app can be configured such that imported files are automatically encrypted by the processor upon importation. For example, the files can be encrypted using AES 256. Preferably, the encryption is performed on the client component such that the content is never sent to the back-end server for encryption. Further, once the file is encrypted, the configured processor can store the file locally (e.g., on the user's computing device) or remotely (e.g., cloud storage). A user can also import files that have already been encrypted, in which case the configured processor can store the file locally or remotely.

With further reference to FIG. 5, at step S215, 1U Turing determines whether the newly encrypted electronic file was imported from a storage location controlled by the user (e.g., his or her photo library or cloud storage) or whether it was imported from an outside source (e.g., email attachment, downloaded from the internet). More specifically, 1U Turing configures the processor to detect the location that the file originates from. If the newly encrypted file was imported from a storage location controlled by the user, the processor can be configured to delete the original unencrypted version of the file and/or replace the unencrypted version of the file with the encrypted version in the original storage location. At step S220, 1U Turing can further configure the processor to determine whether the file was imported from the user's cloud storage or the user's local file library (e.g., photo library). If the file was originally imported from the user's local library, the processor is configured to display a notification asking whether the user wants to delete the unencrypted version of the file after encryption (step S225). If the user responds “yes” (via user input), then at step S230, 1U Turing (executed by the processor) receives the user input and causes the processor to delete the unencrypted version of the file. Similarly, if the file was originally imported from the user's cloud storage, then at step S235 the processor is configured to display a notification asking whether the user wants to replace the unencrypted file with the encrypted version in cloud storage. Again, if the user responds “yes” (via user input), then at step S240, the configured processor deletes the unencrypted file in cloud storage and replaces it with the encrypted version. It should be appreciated that in one or more implementations, the processor can be configured to save both the encrypted and unencrypted files in storage or replace the unencrypted file with the encrypted file regardless of the type of storage. Alternatively, if the file was imported from an outside source that is inaccessible to the user, say, as an attachment to an e-mail received from an outside source or a browser download, the processor can be configured to, at step 217, skip the steps for replacing the source file because the source file location is inaccessible to the user.

In at least one implementation, the 1U Turing client app can provide adjustable settings that allow a user to select a default preference for deleting and/or replacing unencrypted files. For example, based on the settings, the processor can be configured to automatically delete (or keep) the unencrypted version of the file from its original storage location (e.g., cloud storage) upon encryption and/or replace it with the newly encrypted version of the file. However, in instances in which the newly encrypted file was imported from a source not controlled by the user (e.g., email attachment, internet download), the encrypted file is simply stored locally by the device.

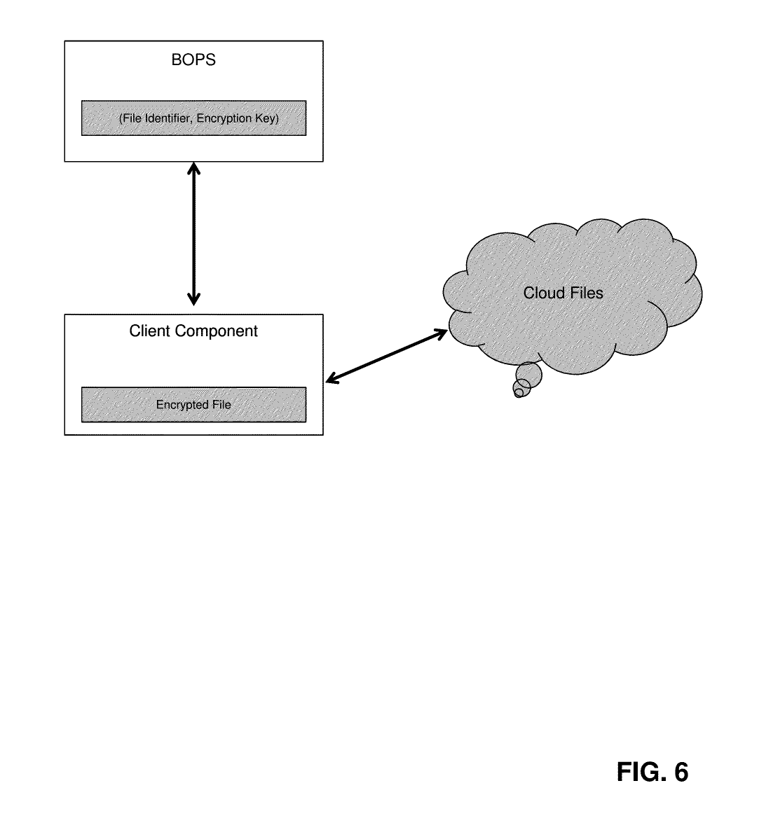

Once the file has been encrypted, the file can be registered in a BOPS backend server. More specifically, 1U Turing can configure the processor to generate and encode the file with a file identifier and a file decryption key, and then cause the file identifier and file decryption key to be saved on the BOPS backend server. A flow diagram displaying the transmission of the encrypted file and the file information (e.g., file identifier, decryption key) between the client component and BOPS is shown in FIG. 6. As explained in more detail below, for certain subsequent actions with the encrypted file (e.g., sharing, opening, deleting), authentication by a user can be required. Upon successful authentication, the file decryption key will be available for the client component to decrypt the file. This decryption key, however, is preferably not stored on the client component.

Once a file has been encrypted, the user (file owner) can then manage and interact with the encrypted file using 1U Turing. For performing these management tasks, 1U Turing can also include an application programming interface (API) for communicating with the back-end server devices and coordinated execution of the selected operations by the mobile device and the back-end servers. The API based operations of the 1U Turing application can include opening files, sharing files, deleting files, and saving files. In a preferred implementation, the API methods of opening files, sharing files, and deleting files all require user authentication, and include the following general steps.

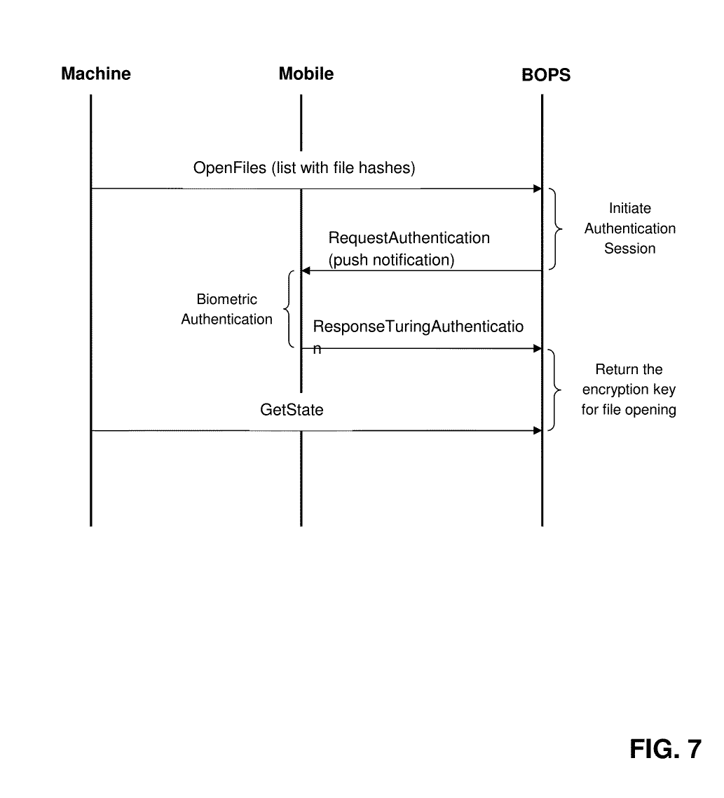

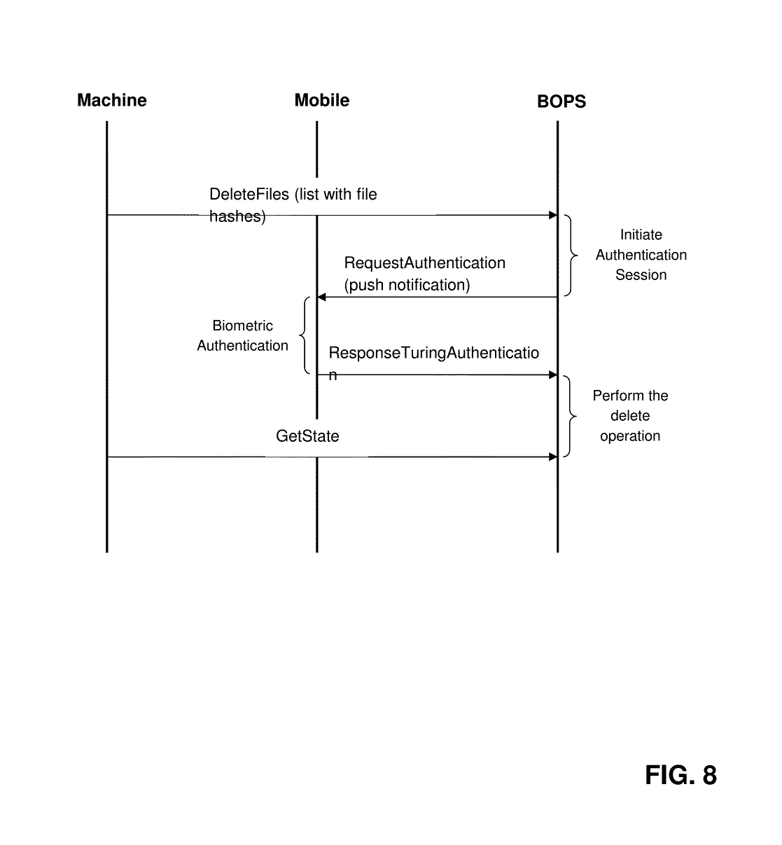

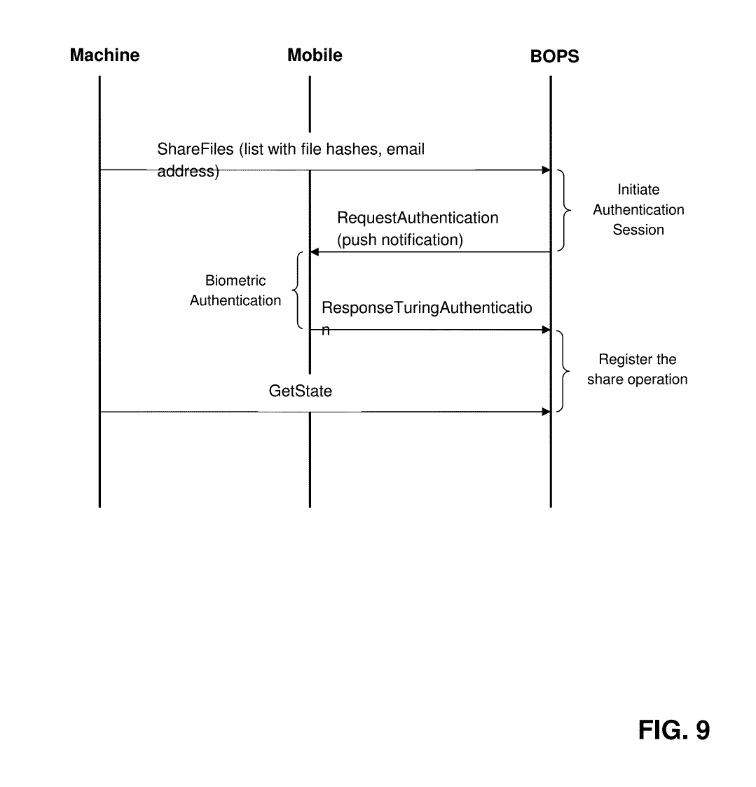

First, in response to initiation of an operation through the 1U Turing application, the application configures the processor to transmit a request to the back end server (e.g., BOPS/HoyosID/1U server) to perform the desired operation (e.g., opening a file). If the operation requires biometric user authentication, the BOPS server creates an authentication session to facilitate biometric authentication of the user before prior to conducting the operation. This can include sending a request (e.g., push notification) for user authentication back to the mobile device, for instance, via the 1U Turing application, or an associated biometric authentication application, that causes the mobile device to biometrically authenticate the user's identity. After completion of the user biometric authentication, the configured processor can transmit the result of the user authentication to the BOPS backend server for further security checking and user authorization by the backend. The BOPS server then verifies the biometric authentication, validates the security of the authentication session, performs additional authorization/verification of the user and sets a new session status accordingly. More specifically, if user authentication is successful, then the API method returns a “sessionID” for the authentication session to the user device, and 1U Turing can configure the device processor to perform the desired operation. Sequence diagrams for the “opening file,” “deleting file” and “sharing file” operations are shown at FIGS. 7, 8, and 9, respectively, which depict the transmission of messages (e.g., file information, push notifications, authentication results) between the client device (machine) and/or mobile device, and BOPS.

If the user authentication is unsuccessful (e.g., the user's ID does not match an ID on the list of authorized users for the file), then the API method returns an error code to 1U Turing. Example systems and methods for coordinating biometric authentication of a user using a mobile device are more fully described herein and in co-pending and commonly assigned U.S. patent application Ser. No. 14/276,753, entitled “SYSTEM AND METHOD FOR AUTHORIZING ACCESS TO ACCESS CONTROLLED ENVIRONMENTS” filed May 13, 2013.

As previously noted, the 1U Turing application and infrastructure is operable using various types of user devices (e.g., desktop, tablet, mobile device, etc.) and, as such, multiple devices associated with a single user can be used to implement the features and functionality described herein. For instance, a user request to perform an operation using the 1U Turing application can be transmitted to the backend server from a 1U Turing enabled desktop device. In response, the backend server can coordinate biometric authentication of the user by the user's personal mobile device. Upon successful user authentication, the requested operation can be performed by the enabled desktop device, either alone or in combination with the back-end server and/or the mobile device. It can also be appreciated that, depending on the operation, the operation can be performed by either the requesting client device or the back-end server, individually or in combination (see FIGS. 7-10).

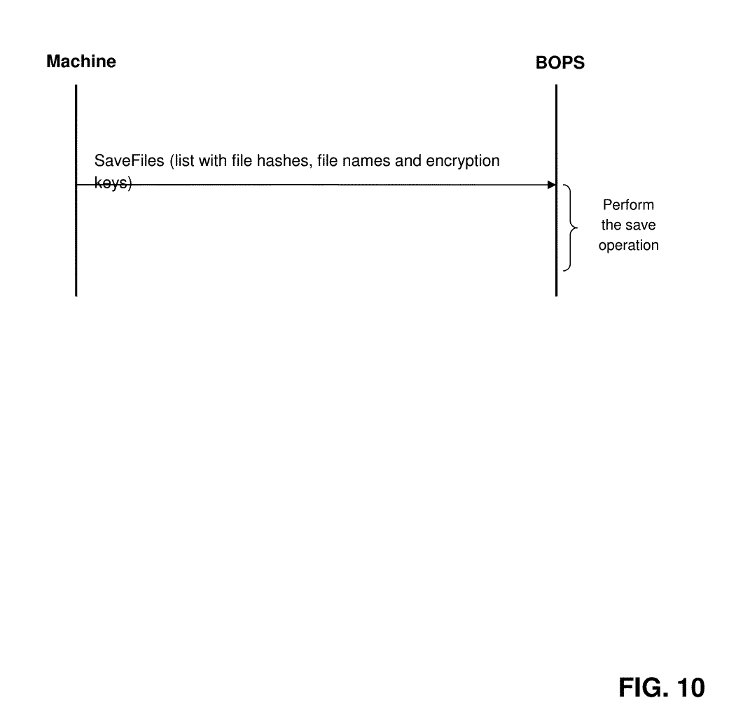

The API method for saving a file comprises similar steps as the other API methods, but does not require authentication. A sequence diagram for the “saving a file” operation is shown at FIG. 10, which depicts the transmission of messages between the client device (machine) and/or mobile device, and BOPS. In reference to FIG. 10, first, a request to perform the “save file” operation is sent from 1U Turing (executed by a processor) to the BOPS server. Next, the BOPS backend server can be configured to save the file information provided in the request (e.g., hash, file name, encryption key) into electronic storage along with other information associated with the file that can be provided by BOPS (e.g., account ID). In one or more implementations, the file information can be generated by the computing device and/or BOPS. For example, the computing device can generate the file id, hash, and file name, while BOPS can generate the encryption key, the encryption initiation vector, and the account ID and/or list of account IDs. The BOPS server can store the file information in the form of field names. Examples of the field names of the file information saved by the BOPS backend server are provided in Table 1.

TABLE 1
Field Names and Descriptions (Group Information)

| Field Name | Description |
|---|---|
| id | The identifier of the file from the server |
| hash_s | The hash value uniquely identifying the file, |
| | generated from the client |
| fileName_s | The file name |
| encryptionKey_s | The encryption key used for file |
| | encryption/decryption |
| encryptionIV_s | The initialization vector used for file |
| | encryption/decryption |
| accountId_s | The ID of the account that owns the file |
| sharedWithAccount_ss | Multiple value field, containing the list of |
| | account IDs with whom the owner account |
| | is sharing the file |

In one or more implementations, 1U Turing can configure the processor to request for the file information of multiple files to be saved at one time. As such, the BOPS server can cause the file information for multiple files to be saved together as one encrypted archive file in the storage. The encryption key for the archive file can be generated by the client application and can be sent together with the file hash value and the file name as a parameter of the saving operation.

As mentioned above, once a file has been encrypted via 1U Turing, the user can manage and interact with the file in many ways. For instance, a user can view an encrypted file that he or she owns or an encrypted file he or she has shared access to. The user interface of 1U Turing Mobile allows the user to open and view an encrypted file using the file viewer component.

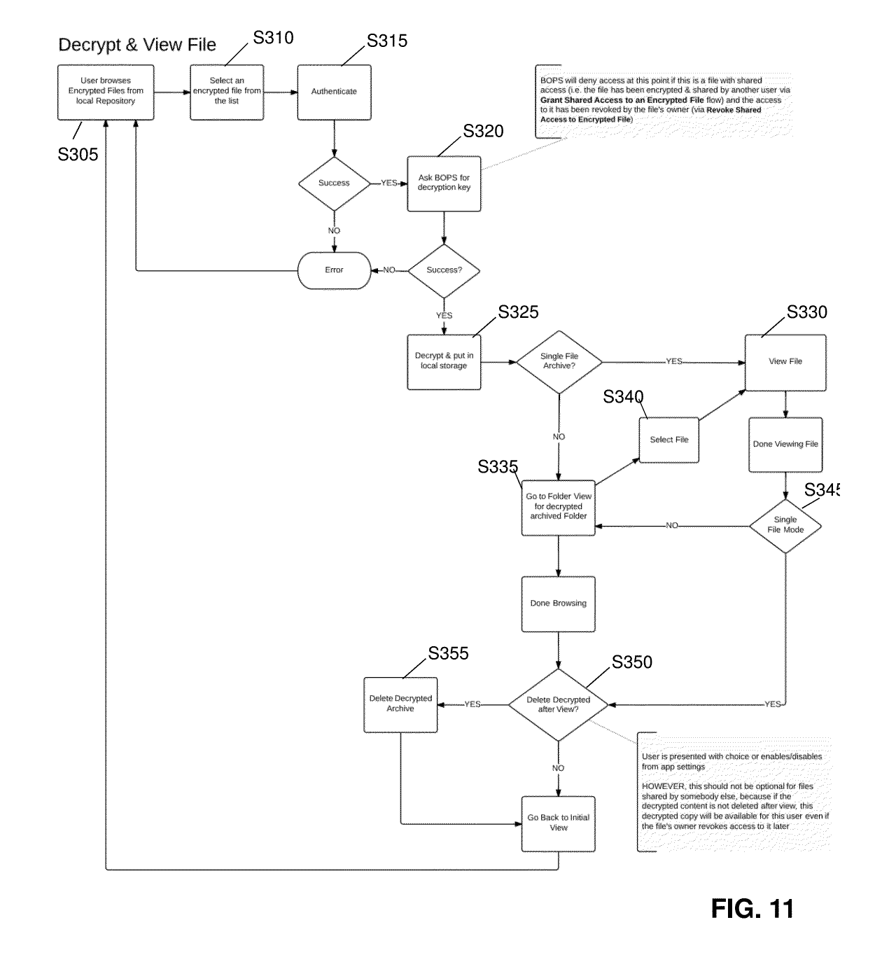

FIG. 11 shows an example process flow diagram for the opening and viewing an encrypted digital media file using the file viewer. As shown in FIG. 11, the process begins at step S305, where the local repository is provided to the user for browsing encrypted files (or an encrypted folder containing multiple files). At step S310, an encrypted file is selected. Specifically, 1U Turing configures the processor to receive a user selection of a particular file. Once the file has been selected, at step S315, 1U Turing configures the processor to perform biometrics based user authentication. If the authentication is successful, then at step S320, 1U Turing configures the processor to send a request to open the selected file (which requires decryption) to BOPS. The request can identify the files to be opened by including a list of files and file hashes. The request can also include an indication that biometric authentication has been successfully completed by the mobile device. It can be appreciated that the information included in the request and/or the biometric authentication result can be transmitted in one or more separate transmissions. BOPS is configured to, in response to the request identify the files that the particular user requests to be opened. In addition, the BOPS server can retrieve from storage one or more access rules associated with the identified file. and the authenticated user identity, can authorize the user to open the key. BOPS then transmits the decryption key saved on the BOPS server to the mobile device for decryption of the file by the configured device processor. At step S325, 1U Turing configures the processor to receive the decryption key and decrypt the file using the received key. The processor is then configured to save the newly decrypted file in local storage. However, despite successful authentication and the user's access to the encrypted file in local or remote storage, under certain circumstances, the BOPS server may not provide the decryption key to the mobile device. For example, if the selected file is subject to shared access and another user (who is the file owner) has revoked the requesting user's access to the file, then even after successful authentication, the BOPS server can deny the user access to the file (e.g., the BOPS server processor the mobile device with an error message rather than the decryption key).

With further reference to FIG. 11, at step S330, 1U Turing configures the processor to display the decrypted file on the computing device. In instances in which the processor has decrypted a folder containing multiple digital media files, at step S335 the decrypted folder is browsed for a file, and at step S340, a file from the decrypted folder is selected for viewing. After selection, 1U Turing configures the processor to display the file on the computing device. If after viewing the user later wants to view another file from the decrypted folder, then the user can navigate back to the decrypted folder (step S345) and select another file for viewing from that folder without having to re-authenticate his or her identity. In one or more implementations, when the user is done viewing the file (e.g., user input causes the processor to close the file), at step S350, 1U Turing configures the processor to prompt the user to delete (or save) the decrypted file after viewing. A responsive user input can then cause the processor to either delete the file or save the file. In at least one implementation, the decision whether to delete the decrypted file after viewing can be made automatically by the configured processor, for example based on settings such as an enabled or disabled “delete after viewing” rule defined in the settings of the 1U Turing application. In some implementations, the processor is configured to automatically delete an unencrypted version of a file after viewing when the user is not the file owner of that file. In these instances, the processor is configured to delete the file automatically after viewing, which prevents the user from maintaining a decrypted version of the file locally. This feature ensures that if the file owner later wants to revoke access from the user, the file owner is able to do so. Once the viewed file has been deleted at step S355 (or saved), the 1U Turing (executed by the processor) can be configured to revert back to the initial file viewer screen for further browsing of encrypted files, either by default or in response to a user input.

In addition to decrypting and viewing files, the 1U Turing application is also configured to allow a file owner to select other users to share secure files with. When the file owner wants to share a secured file with one or more users, the secured file itself can be sent to the user(s) via traditional channels (e.g., email, cloud sharing, etc.). However, due to the example process for encrypting and selectively providing access to the necessary decryption keys by the BOPS server, the receiving user can only gain access to this file if the file owner grants shared access to the file via 1U Turing. Conversely, the file owner can also, at any time, revoke access to the secure file from one or more users. It should be noted that in at least one implementation, a user who is not the file owner can facilitate access to the file to a third user; however, that user must first receive permission from the file owner in accordance with previously discussed aspects of the technological infrastructure of the present application such as, for example, associated with a device operating the 1U App.

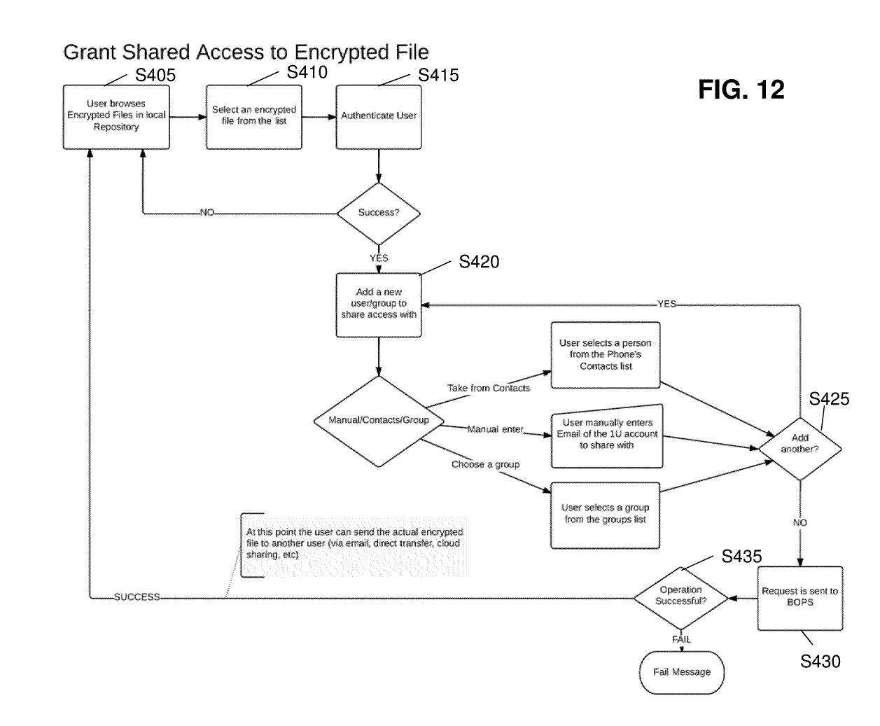

FIG. 12 shows an example process flow diagram for managing access to files using the file share access manager feature of the 1U Turing application executing on a client device. With reference to FIG. 12, at step S405 a file owner's local repository of files is browsed. At step S410, 1U Turing configures the processor to receive a user input selecting a file from the repository. To share the selected file, the file owner must then authenticate his or her identity at step S415. If authentication is successful, then at step S420 1U Turing configures the processor to receive a selection (user input) of a contact to share access with for the selected file. In one or more implementations, the contact can be chosen from the file owner's contact list stored on the computing device. Alternatively or in addition, 1U Turing can configure the processor to receive manual user inputs (e.g., email addresses) identifying the contacts for shared access. In addition or alternatively, the user can select a contact from contact lists provided by integrated third party applications (e.g., email, messaging, sms, social media applications and the like). The 1U Turing application can also allow a user to identify a group of users to share access with. Once a contact (or group) has been selected, to the configured processor can display a request for additional contacts to share with (step S425). When all contacts for sharing have been selected, then at step S430, the configured device processor can transmit, to the BOPS server, a request to share the secured file.

In response to the share request the BOPS server associates the record of the shared file in the storage with a record of the contacts that have been approved to access the shared file.

At step S435, BOPS transmits a confirmation back to the sharing user device if the operation is successful and transmits an error message back to the device the operation is unsuccessful. For example, if the email address of one or more selected contacts does not belong to a 1U account, then the share operation will be unsuccessful. In at least one implementation, if only some of the selected contacts are not 1U account holders, then 1U Turing can configure the processor to receive both a confirmation of successful sharing for 1U account contacts, and an error message for non-1U account contacts. In response to a successful sharing operation for one or more contacts, the 1U Turing application can further configure the processor to transmit the secured file(s) to the selected contacts. The sharing of the files can be conducted via instances of the 1U Turing app executing on respective user devices or via integrated third party applications (e.g., email, message, social media) and the like.

In addition to facilitating the sharing of encrypted files with individual contacts, 1U Turing is also configured to allow the file owner to share files with groups of users. In one or more implementations, groups can be defined at a system level and at user level. More specifically, groups defined at a system level (“system groups”) can be available to all 1U users and can be managed by an administrative dashboard and/or administrative user(s). System groups can be further defined by their scope. Specifically, “global” system groups are those that are available to all users registered in the system, while “group” system groups are available only to users that belong to that user. [NOT SURE WHAT IS MEANT BY “GROUP” SYSTEM GROUP]

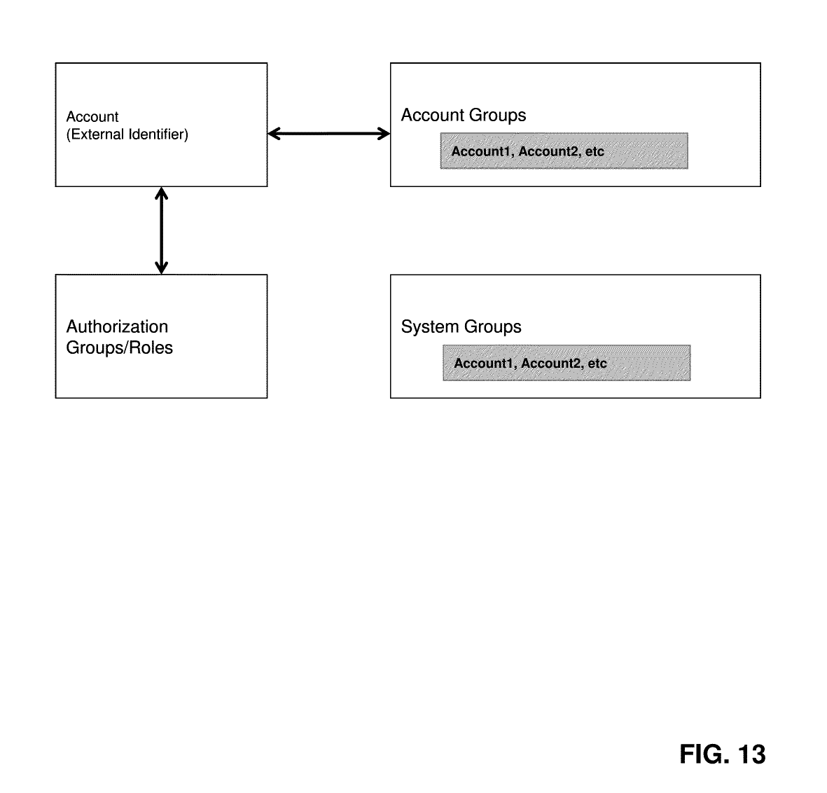

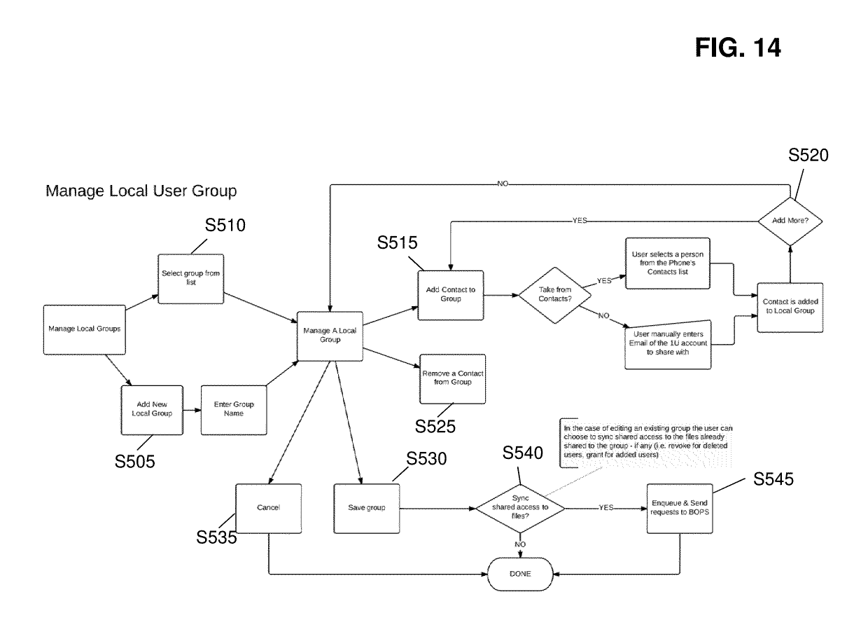

Conversely, groups defined at the user level (“account groups”) are groups that can be created and managed by the user while he or she is using the client components of 1U Turing. In other words, the user not only creates the group of other users, but manages the authorization for users to access to his or her files, and the addition and/or removal of users from the group. In one or more implementations, an account group can only be managed by the user that creates the account group. FIG. 13 displays an example block diagram showing the relationship between account groups and system groups. The management of account groups by users is explained in further detail below, and in reference to FIG. 14.

In one or more implementations, sharing a file (or a set of files) with a group can be done in two different ways (types): a distribution list type, and a destination group type. For the distribution list type, a file owner can select a group of users (“distribution list”) for sharing, and each user on the distribution list will be individually assigned as a destination for the shared file(s). In other words, the shared files will be sent to each user in the group, individually. For this type, if a user is removed from the distribution list, the previously shared files will still be accessible for that user.

In the destination group type, the group of users, itself, will be the destination for the shared file(s). In other words, the group will be assigned an ID, and the group ID will be the destination for the shared file(s). In this type, each user in the group is given access (e.g., rights to open) to the shared file by being a member of the group. However, if a user is removed from the group, access to all files shared in the group—including those shared prior the user's removal from the group—is revoked.

For API operations involving groups (e.g., creating a group), the BOPS server can save the group information in the form of field names. Examples of the field names and corresponding description of the group information saved by the BOPS backend server are provided in the below Table 2, including a field identifying the type of sharing (i.e., distribution list vs. destination group).

TABLE 2
Field Names and Descriptions (Group Information)

| Field Name | Description |
|---|---|
| id | The identifier of registration in repository |
| name_s | The name of the group |
| description_s | The description of the group |
| type_s | DISTRIBUTION_LIST/DESTINATION_GROUP |
| accountId_s | The ID of the account that owns the group. |
| | Is empty in case of system group. |
| accounts_ss | Multiple value field, containing the list of |
| | account IDs that belongs to the destination. |

FIG. 14 shows an example process flow diagram for the management of local groups (“account groups”) via the local groups manager component of user interface. In reference to FIG. 14, the process begins at step S505, where 1U Turing, which is executing in the mobile device processor, configures the processor to begin creation of a new group. Alternatively, the process can begin at step S510, where the configured processor to receives a selection of a group (via user input) from a list of existing groups. After creation or selection of a group, the group can be managed in several ways. For example, at step S515, the configured processor can add a contact to the group based on user input. A new contact can be chosen by the user as previously noted. In one or more implementations, the configured processor can display a list of contacts that comprises only those who are already 1U App users for selection for the group. Alternatively, in at least one implementation, 1U Turing can configure the processor to display a contact list including both 1U and non-1U users, wherein the displayed list includes icons identifying those contacts that are 1U App users. Once a contact has been added to the group, 1U Turing can configure the processor to display a request to add one or more additional contacts to the group at step S520. In addition, at step S525, the configured processor can also provide the user the option to remove contacts from the group.

With continued reference to FIG. 14, at step S530 the configured processor saves, in storage, any changes (e.g., additions, deletions) made to the group based on the user's selections. Prior to saving, at step S535, the configured processor can also prompt the file owner to confirm changes made to the group during the session. After changes are saved, 1U Turing configures the processor to display a notification asking the user whether he or she would like to sync the changes for access to the files already shared in the group (step S540). If the user has added a contact to an existing group, syncing the changes would grant access to the files already shared in the group to the newly added contact. Likewise, if the user has deleted a contact from the group, syncing the changes would revoke access to the files for the deleted contact. At step S545, if the user opts to “sync” the changes for access to the files, 1U Turing configures the processor to transmit a request to BOPS to record the new list of contacts and, in response, BOPS will either store or update the group record as provided by the request and return a confirmation back to the 1U Turing enabled mobile device if syncing is successful.

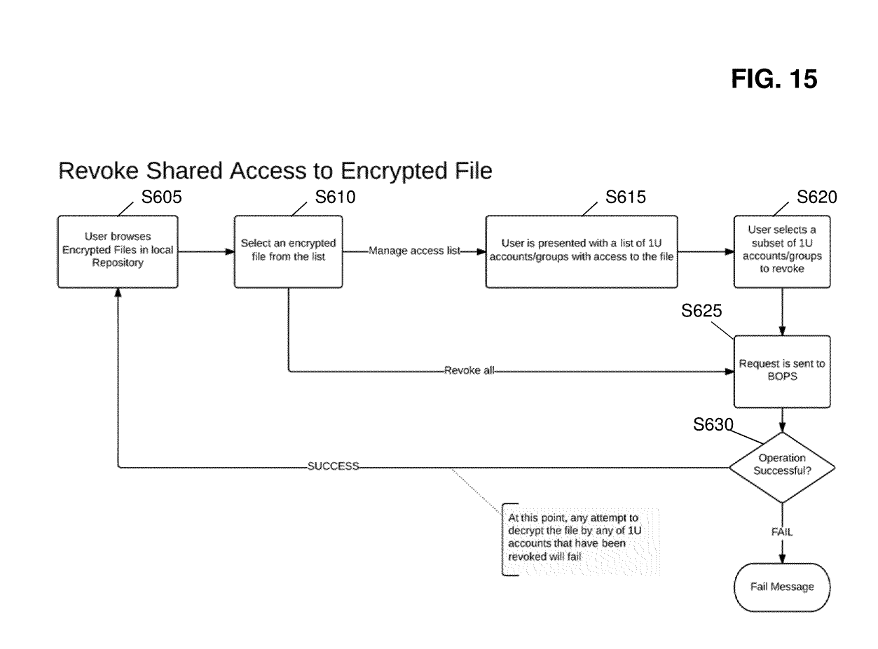

The user interface also allows the file owner to revoke shared access to an encrypted file from one or more users, or a group of users. FIG. 15 shows an example process flow diagram for the revocation of shared access to a secured file using the file share access management component. With reference to FIG. 15, at step S605 the user's local repository of secured files is browsed. At step S610, 1U Turing configures the processor to receive a user input selecting a secured file from the repository. Also at step S610, after receiving the file selection, the processor is configured to display a prompt asking the file owner whether he or she wants to revoke access to all users who currently have access to the file, or manage the access list (e.g., revoke access to a select number of users). If the file owner selects “manage access list,” then at step S615 the processor is configured to display a list of 1U users (or groups) that currently have access to the file. At step S620, 1U Turing configures the processor to receive a user input selecting one or more of the users (or groups) from the list. Once users have been selected, 1U Turing configures the processor to transmit a request to BOPS to complete the revocation for the selected users at step S625. At step S630, BOPS sends a confirmation back to 1U Turing if the revocation is successful and an error message if the revocation is unsuccessful. Following successful revocation of access, user input can cause 1U Turing (executed by the processor) to navigate back to the local repository for selection of a different file to revoke access to.

Additional features of the 1U Application and the technological infrastructure of the present application are further described herein. The example implementations are further referred to herein, as “1U-Private,” which refers generally to a application or plug-in implemented on client side devices (e.g., mobile devices/smartphones, tablet computers, desktop computers and the like) and email servers. 1U-Private allows a user to securely send and receive encrypted emails via user authentication with BOPS, utilizing the biometric authorization platform of HoyosID. As further described herein, 1U-Private can be configured to provide both personal email and corporate-based email implementations. In general, the 1U-Private application executing on respective devices includes encoded instructions in the form of one or more software modules that, when executed by the processor of the computing device, configure the processor to perform the various processes described herein.

Conventionally, email users who want to send out encrypted emails cannot simply use their general email client (e.g., Gmail, Microsoft Outlook), but rather the user must also use a secondary system for encryption of the emails. 1U-Private provides a solution to this problem, by integrating into the email client, thereby allowing 1U-Private to control the transmission and receipt of encrypted emails. 1U-Private also provides added security for sending and receiving encrypted emails via user authentication with BOPS. More specifically, 1U-Private configures the email client (as executed by the processor) to transmit emails to BOPS for encryption. In order for the transmission to be to be successful, the sending user must authenticate his identity via 1U-Private. If authentication is successful, the email is sent to BOPS, BOPS encrypts the email (and creates a password for it), and then transmits the encrypted email to the intended recipient.

Similarly, for a recipient of the encrypted email, 1U-Private configures the email client (as executed by the processor) to receive the email for decryption and viewing. In order to decrypt and view the email, the recipient user must also authenticate his identity via 1U-Private. If authentication is successful, the password is transmitted from BOPS to the recipient user and the email is decrypted such that the recipient user can view it. Additional features of 1U-Private are further described in the example implementations below.

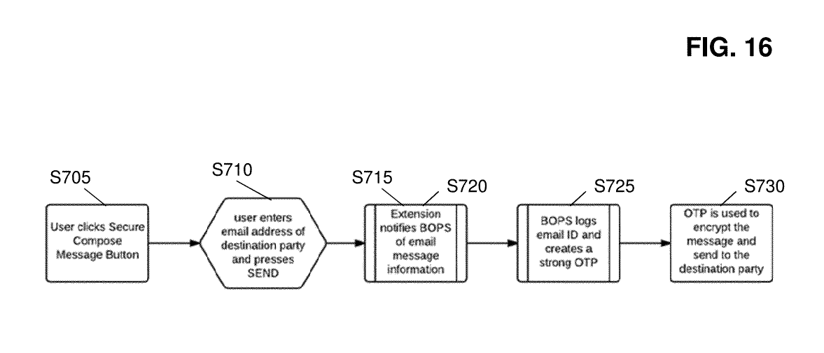

An example process flow diagram for transmitting an encrypted email via 1U-Private is shown at FIG. 16. As shown in FIG. 16, the process begins at step S705, where, after integration of 1U-Private into the email client, user input causes the email client (as executed by processor) to display a email message box for composing a secure (encrypted) email. After the email is drafted, 1U-Private configures the email client to receive a user selection of email address(es) of the one or more intended recipients of the email (step S710). Also at step S710, once email recipients have been selected, 1U-Private configures the email client to receive a user input requesting the encryption and transmission of the email to the recipients. At step S715, the user input requesting encryption and transmission of the email causes 1U-Private to perform a biometrics-based user authentication. As with other aspects of the technological infrastructure of the present application, biometric authentication can be accomplished via a camera device that is configured with or that operates in conjunction with an electronic device as previously described. More specifically, for 1U-Private implemented on a mobile device (e.g., smartphone), biometric authentication can be accomplished via a camera integrated into the mobile device, for example. Further, for 1U-Private implemented on a desktop computing device, biometric authentication can be accomplished via a webcam configured with or that operates in conjunction with the desktop computer.

With further reference to FIG. 16, if the authentication is successful, then at step S720 1U-Private configures the email client (as executed by the processor) to send a request to BOPS to encrypt and transmit the email. The request can identify the email to be encrypted and transmitted, as well as the sender and intended recipient(s) of the email. The request can also include an indication that biometric authentication has been successfully completed. It can be appreciated that information included in the request and/or the biometric authentication result can be transmitted in one or more separate transmissions. At step S725, in response to the request to encrypt and transmit the email, BOPS is configured to log the sender and recipient(s) of the email, as well as an identification of the email message. Continuing with step S725, BOPS is configured to create and store a one-time password for encryption and subsequent decryption of the email. At step S730, BOPS is configured to encrypt the email and transmit the encrypted email to the selected recipients (directly via the 1U private application or indirectly via servers associated with the email client). The email can be encrypted using a variety of ciphers known in the art. In one or more implementations, the email is encrypted using SHA-1 256 bit methods and/or AES 256 bit methods.

The encrypted email can be delivered to the recipient in the same manner as a normal (unencrypted) email, except that the encrypted email transmission can provide an indication that informs the user that he or she must use 1U-Private to decrypt and view the email. For example, in the recipient user's list of received emails viewed via the email client, emails encrypted via 1U-Private can be denoted by a symbol (e.g., closed lock). In at least one implementation, the receipt of an email encrypted via 1U-Private can cause 1U-Private (as executed by a processor) to display a message on the computing device, indicating that the email must be decrypted using 1U-Private.

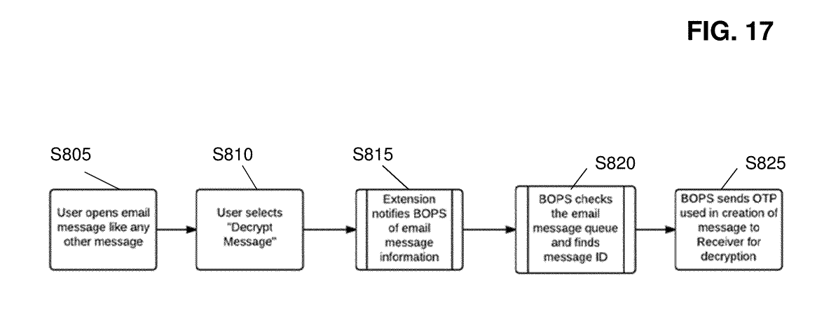

An example process flow diagram for receiving an encrypted email via 1U-Private is shown at FIG. 17. As shown in FIG. 17, the process begins at step S805 where after integration of 1U-Private, user input causes the email client (as executed by a processor) to open the secured (encrypted) email. Continuing with step S805, the user input causes 1U-Private (as executed by a processor) to display a request for user authentication to decrypt the email. At step S810, user input causes 1U-Private to perform a biometrics based user authentication for the recipient user, for example, in the manner previously described. If the authentication is successful, then at step S815, 1U-Private (in conjunction with the email client) transmits to BOPS a request for the decryption password. This transmission can include information identifying the encrypted email, as well as information identifying the recipient and sender (e.g., recipient email address and the sender email address). At step S820, BOPS is configured to confirm the biometric authentication and validate the request to decrypt the email, for example as described above, retrieve the password associated with the encrypted email, and then transmit the password for the encrypted email to the recipient user. In one or more implementations, the password transmitted by BOPS is the same password used to encrypt the email. At step S825, 1U-Private (in conjunction with the email client) configures the processor to receive the password and decrypt the email message. After the recipient user has read the decrypted email and closed the email, 1U-Private configures the email client to automatically revert the decrypted email to its encrypted form.

In one or more implementations, the 1U-Private can be configured to provide adjustable settings that allow a user (or administrative user) to select one or more default preferences. For example, 1U-Private can configure the email client (as executed by a processor) to automatically encrypt all transmitted emails and require user authentication by the recipient to read them. Alternatively, 1U-Private can configure the processor to allow each user to select which emails to encrypt. Further, 1U-Private can provide adjustable settings that control operation of the 1U-Private application including biometric authentication performed by the mobile device and the BOPS server. More specifically, in one or more implementations, settings can be defined by the user via a client side user interface and recorded locally and on the BOPS server for implementation during authentication. For instance, according to the settings, BOPS can be configured to authorize a user upon successful biometric authentication based on one or more prescribed biometric vectors (e.g. face, fingerprint, voice or one or more combinations of the foregoing). In one or more implementations, settings can define which biometric vector(s) are required for authentication. In at least one implementation, an administrative user can set the number and/or type of biometric vectors required for authentication. In one or more implementations, 1U-Private can be configured by the settings to allow biometric authentication using webcam (desktop computer) and/or a camera integrated into the mobile device. Alternatively, 1U-Private can be configured to allow biometric authentication using a webcam only (or, alternatively, only using a camera integrated into the mobile device). In at least one implementation, 1U-Private can be configured to allow for “session authorization” such that a user is only required to authenticate his or her identity once during a session, and can then encrypt and decrypt messages during the session without addition authentications. For example, a user can authenticate his or her at the beginning of the session (e.g., when the user logs into the email client), and subsequently encrypt and decrypt messages without additional authentication until the session is over (e.g., when the user logs off of the email client).

As previously mentioned, 1U-Private can be implemented on any number of client-side computing devices (e.g., mobile devices/smartphones, tablet computers, desktop computers and the like), and can be integrated into any number of native and web-based email clients (e.g., Gmail, Microsoft Outlook, Yahoo! Mail, AOL Mail). It should also be understood that 1U Turing—a related client-side application discussed above—can be integrated into third party applications in a similar way as 1U-Private such that 1U Turing can configure the third party app (as executed by a processor) to communicate with BOPS.

It is to be understood that like numerals in the drawings represent like elements through the several figures, and that not all components and/or steps described and illustrated with reference to the figures are required for all implementations or arrangements.

The figures illustrate the architecture, functionality, and operation of possible implementations of systems, methods and computer program products according to various implementations and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The subject matter described above is provided by way of illustration only and should not be construed as limiting. The terminology used herein is for the purpose of describing particular implementations only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example implementations and applications illustrated and described, and without departing from the true spirit and scope of the present invention, as set forth in each and any of the following claims.

What is claimed is:

1. An authorization system for coordinating secured access to an access-controlled environment as a function of biometric authentication of the user, the system comprising:
a processor configured to execute electronic instructions;
a non-transitory computer readable storage medium that is accessible to the processor, wherein at least some of the electronic instructions are stored on the storage medium;
a plurality of keys stored in the storage medium, each of the keys respectively associated with a respective user account and generated, based on confirmation of a respective user's identity by a respective computing device executing a biometric authentication application, using identification information concerning the respective user and a component of the of the respective computing device;
a communication module configured to communicatively connect the processor to at least one computing device over a network connection, and wherein the processor, executing the communication module, is configured to receive:
i) access-control information that identifies an access-controlled environment; and
ii) one or more transmissions from a computing device that each include a respective key and an indicator indicating that the user's identity has been biometrically confirmed by the computing device;
an authorization module that, when executed by the processor, configures the processor to:
verify that the received key corresponds to at least one of the respective keys,
determine, based on the indicator and the key, that the computing device has biometrically confirmed the identity of the user using the biometric authentication application,
confirm that at least one of the one or more transmissions is not a replay of a previously received transmission from the computing device, and
facilitate, over the network with a remote computing device based on the information that identifies an access-controlled environment, the user access to the access-controlled environment as a function of the verification, determination and confirmation.

2. A method for secure sharing of an encrypted electronic file between users based on biometric authentication of the users performed using respective user computing devices, the method comprising:
receiving, at a server computing device that includes a storage medium having instructions stored therein and a processor configured by executing the instructions, from a first user computing device over a network connection:
information identifying the encrypted electronic file (“fileID”), wherein the encrypted electronic file is stored in a file storage medium that is accessible by the first user computing device;
an encryption key;
access control information identifying at least a recipient user who is authorized to access the encrypted electronic file;
receiving, at the server computing device over the network connection, one or more biometric authorization messages, each biometric authorization message being from a respective user computing device and including identification information associated with a respective user of the respective user computing device, and the identification information including a representation of the respective user's identity that has been confirmed as a function of biometrics;
verifying, by the server computing device in accordance with a datastore of user accounts associated with respective users and respective user computing devices, that the identification information corresponds to a user account that is associated with the first user and the first user computing device;
generating, by the server computing device, a record of the encrypted electronic file in the storage medium, wherein the record comprises the fileID, the encryption key, the access control information and the userID;
providing, by the server computing device, a registration notification to the first user computing device that is usable for the first user computing device to transmit the encrypted electronic file to a second computing device associated with the recipient and wherein the registration notification causes the first user computing device to erase any locally stored copies of the encryption key.

3. The method of claim 2, further comprising:
receiving, at the server computing device, an access request from a second user computing device, wherein the access request identifies the fileID and identifies the recipient user;
verifying, by the server computing device according to the datastore of user accounts, that the identification information included in a biometric authorization message received from a second user computing device corresponds to a second user account that is associated with the recipient user and the second user computing device;
determining, by the server computing device and in accordance with the received fileID, the stored file record and the recipient user, that the access control information identifies the recipient as an authorized user; and
providing, by the server computing device based on the determination, the encryption key to the second user computing device.

4. The method of claim 2, further comprising:
establishing a two-way secured communication session between the server computing device and at least one user computing device;
determining, by the server computing device, an object security level associated with an object and a subject security level associated a user of the at least one user computing device; and
facilitating, by the server computing device, access to the object by the at least one user computing device when the subject's security level is greater than or equal to the object's security level.

5. The method of claim 4, wherein establishing the two-way secured communication session between the first user computing device and the server computing device comprises:
transmitting, by the server computing device to the first user computing device over a network, an instruction that, when executed by the first user computing device, causes the first user computing device to launch an application window;
wherein the two-way secured communication session is established between the first user computing device and the one server computing device via the application window, and
establishing the two-way secured communication session based on the verification of the user with the first user computing device automatically provides direct and pre-authorized access to an access controlled environment hosted by the remote computing device via the application window.

6. The method of claim 4, wherein the server computing device is a secure webserver.

7. The method of claim 6, wherein the two-way communication session is established directly between the secure webserver and the first user computing device or a second user computing device.

8. The method of claim 4, wherein the two-way communication session is established between the secure webserver and the second user computing device indirectly.

9. The method of claim 2, further comprising:
identifying, in accordance with the encryption key, a respective user computing device that is associated with the first user; and
receiving, by the server computing device from the first computing device, access control information that corresponds to the access-control information.

10. A method for secure sharing of an encrypted electronic file between users based on biometric authentication of the users performed using respective user computing devices, the method comprising:
transmitting, by a server computing device to a first user computing device, a request to confirm identity of a first user associated with the first user computing device;
receiving, by the server computing device in response to the request and from the first user computing device, a confirmation of the identity as a function of biometric authentication by the first user computing device;
determining, by the server computing device, a key that is unique to the first user, the first user computing device and the confirmation that the user identity using biometric authentication by the user computing device;
validating, by the server computing device and in accordance with the key, the confirmation, the identity of the user and the user computing device based on the biometric authentication, a secure communication session; and
constructing, by the server computing device and using the key, the validated secure communication session over a network between the server computing device and the first user computing device associated with the validated user.

11. The method of claim 10,
wherein the biometric authorization comprises one or more keys and a biometric authentication status; and further comprising:
associating a plurality of user accounts with one or more stored keys that are each uniquely associated with respective users and respective user computing devices;
verifying, by the server computing device, that a key received from the first computing device corresponds to at least one of the one or more stored keys is associated with the first user and the first user computing device to confirm that the first user was biometrically authenticated by the first user computing device.

12. The method of claim 10, wherein the validating comprises:
verifying the identity of the first user by testing the key against one or more previously stored plurality of identity assertion keys, wherein each identity assertion key is unique to a respective enrolled user and the enrolled user's associated user computing device; and
confirming, by the server computing device, that a user computing device is associated with the verified user.

13. The method of claim 10, further comprising:
receiving, by the server computing device from the first computing device, a transaction request that comprises the key, and
comparing, by the server computing device, the key to a respective key included in at least one user profile.

14. The method of claim 13, wherein the at least one user profile includes transaction account information concerning a transaction account, and further comprising:
retrieving, by the computing device from at least one database, at least one access rule, wherein the user is authorized to access an access-controlled environment based on the transaction account information and the at least one access rule.

15. The method of claim 14, further comprising:
generating, by the server computing device, an authorization notification that grants the first user computing device access to the access-controlled environment; and
transmitting, by the server computing device to the first computing device, the authorization notification.

16. The method of claim 15, wherein the at least one remote computing device is associated with the first user, and wherein the authorization notification causes the at least one remote computing device to:
retrieve, from a memory in accordance with the authorization notification, account details associated with the at least one transaction account, and
transmit at least the account details to a remote computing device that grants access to the access-controlled environment.

17. The method of claim 16, wherein the at least one remote computing device is the user computing device.

18. The method of claim 15, wherein the authorization notification includes at least one of:
a password;
a user identifier;
a user computing device identifier;
a transaction request;
access-control information;
information concerning the at least one transaction account;
information indicating that the user has been authorized to access the access-controlled environment; and
information indicating that the user has been biometrically authenticated.

19. The method of claim 14, wherein the access-controlled environment includes one or more of:
a physical location;
one or more computing devices;
a computer storage device;
a database; and
an electronic device.

20. A system for authorizing access to an access-controlled environment, the method comprising:
a network communication interface;
a computer-readable storage medium;
one or more processors configured to interact with the network communication interface and the computer-readable storage medium and execute one or more software modules stored on the storage medium including;
a database module, that when executed configures the one or more processors to access at least one database that includes user profiles that include information to identify respective users, respective user computing devices and respective transaction accounts that are associated with respective access-controlled environments;
a communication module that when executed configures the one or more processors to receive access-control information that identifies the access-controlled environment, and to receive from a user computing device over a network, a transaction request including:
a user identifier that identifies a user, and
a user computing device identifier that identifies the user computing device, wherein the transaction request provides confirmation that the user computing device has biometrically authenticated the user;
an authorization module that that when executed configures the one or more processors to process, using the at least one database, the transaction request to authorize the user to access the access-controlled environment by determining:
that the user identifier is associated with at least one user profile stored in the at least one database,
that the user computing device identifier is associated with the at least one user profile, and
that the at least one user profile identifies a transaction account associated with the access-controlled environment;
wherein the authorization module also configures the one or more processors to generate an authorization notification that facilitates the authorized user to access to the access-controlled environment; and
wherein the communication module further configures the one or more processors to transmit the authorization notification to at least one remote computing device over a network.
